(19) United States
(12) Patent Application Publication
(10) Pub. No.: US 2025/0135809 A1
(43) Pub. Date: May 1, 2025

(54) PNEUMATIC VALVE, PUMP HEAD AND ACCESSORIES FOR A PNEUMATIC VALVE

(71) Applicant: Clik Corporation, Westlake Village, CA (US)

(72) Inventors: John Quintana, Carnarillo, CA (US); John Walton, Falmouth, ME (US)

(21) Appl. No.: 18/934,627

(22) Filed: Nov. 1, 2024

Related U.S. Application Data
(60) Provisional application No. 63/546,874, filed on Nov. 1, 2023.

(51) Int. Cl. B60C 29/00; F16K 15/20

(52) U.S. Cl. CPC B60C 29/002; F16K 15/20

(57) ABSTRACT

A pump head for a valve and a system having a pump head and a valve are provided. The pump head includes a body having a cavity sized to receive the body, the cavity having at least one engagement member at least partially disposed within the cavity, the at least one engagement member being positioned to align with a circumferential slot when a valve body is disposed in the cavity. The pump head further includes a second projection disposed adjacent an end of the cavity, the second projection being positioned to engage a projection on a valve seal member when the body is disposed in the cavity.

### CROSS-REFERENCE TO RELATED APPLICATIONS

The present application claims the benefit of, and is a nonprovisional application of, U.S. Provisional Application 63/546,874 filed Nov. 1, 2023, entitled A PNEUMATIC VALVE, PUMP HEAD AND ACCESSORIES FOR A PNEUMATIC VALVE, the contents of which is incorporated by reference herein.

### FIELD OF THE INVENTION

The present disclosure relates generally to a pneumatic valve system such as for use with tube and tubeless bicycle tires and methods of making and using the same. More particularly, the present disclosure relates to improved valve systems as an alternative to Schrader, Presta, and Dunlop valves, and other pneumatic valves.

### BACKGROUND OF THE INVENTION

Pneumatic valve systems for connecting a pressurized air source (e.g., a pressurized tank or an air pump) to a pneumatic tire, tube, or other structure have been in use for quite some time. Conventional devices heretofore devised and utilized are widely used, and yet continue to have design drawbacks. These devices are awkward to attach and keep attached while filling a tube or tire, and often do not provide a reliable seal on the valve stem of the tire, tube, or other structure, leading to leaks. Further, a poor coupling between conventional pneumatic valves and air pressure gauges may lead to inaccurate pressure readings and improperly inflated tires, which can reduce gas mileage (or slow a bicycle) and cause uneven wear on the tire, reducing the life of the tire and potentially voiding manufacturer warrantees. While conventional devices fulfill their respective, particular objectives and requirements (i.e., increasing air pressure in a tube or tire), they also have functional drawbacks that can be frustrating. For instance, often times the use of a valve coupling requires a person to be awkwardly and uncomfortably positioned for a length of time while filling a tube or tire. In such situations, reliability in the connection of the valve is highly desirable to avoid as much physical discomfort and wasted time as possible.

The Schrader valve has significant connection problems due to the manner in which the pump-head is secured to the valve stem. Because the seal between the pump-head and the valve is made on the outside of the valve stem, the internal surface area shared between the distal end of the valve stem and the pump-head valve cavity is relatively large. As a result, the internal pressure of the tire or other vessel to which the valve is attached exerts significant force upon internal pump-head surface that can result in the pump-head being blown off of the valve without a mechanism to hold it in place. To properly secure the pump-head to the valve, a locking lever is included in the Schrader pump-head design. The grasping mouth piece of the Schrader pump-head exerts significant force to sufficiently compress the rubber in order to keep the pump-head from “popping” off due to the high instantaneous output pressures from the pump in combination with the building of internal pressure in the tire or other vessel. As a consequence, virtually all Schrader valve pump-heads suffer from the same problem-they are difficult and awkward to lock, requiring two hands and considerable finger strength to mate and lock the pump-head.

The Presta valve has several disadvantages, and is notoriously difficult to use. It has the same issues as a Schrader valve, namely, that the pump-head experiences forces sufficient to blow it off the valve stem without a locking mechanism. The locking lever and chuck are difficult and awkward to handle. The Presta valve has additional difficulties and drawbacks, including the additional inconvenience of having to unscrew the captive nut that forms part of the valve stem structure, the requirement of a specialized pump that fits the specialized Presta design, the delicate and damage-prone design of the Presta valve stem, and the common problem of the threaded core of the Presta valve stem unthreading from the stem housing when engaged with a pump-head.

Thus, there continues to be a need for pneumatic valve couplers that improve upon the concepts and designs of conventional devices.

### SUMMARY OF THE INVENTION

According to an aspect of the disclosure a pump head for a valve having a body with a circumferential slot and a seal member having a first projection is provided. The pump head includes a body having a cavity sized to receive the body, the cavity having at least one engagement member at least partially disposed within the cavity, the at least one engagement member being positioned to align with the circumferential slot when the body is disposed in the cavity. A second projection is disposed adjacent an end of the cavity, the second projection being positioned to engage the first projection when the body is disposed in the cavity.

According to another aspect of the disclosure a system is provided. The system includes a pump head and a valve. The pump head includes a first body having a cavity sized to receive the body, and at least one engagement member at least partially disposed within the cavity; and a first projection disposed adjacent an end of the cavity. The valve includes a second body, a seal member and a seal. The second body has a passageway and a circumferential slot, the circumferential slot being positioned to receive the at least one engagement member when the valve is disposed in the cavity. The seal member has a second projection movably disposed within the passageway. The seal is disposed within the passageway, the second projection being sized to engage the first projection when the valve is positioned within the cavity and displace the seal member from the seal.

The above-described objects, advantages and features of the invention, together with the organization and manner of operation thereof, will become apparent from the following detailed description when taken in conjunction with the accompanying drawings, wherein like elements have like numerals throughout the several drawings described herein. Further benefits and other advantages of the present invention will become readily apparent from the detailed description of the preferred embodiments.

### BRIEF DESCRIPTION OF THE DRAWINGS

FIG. 1 is a side view of a bicycle wheel in accordance with an embodiment;

FIG. 2A is a side view of a pneumatic valve for a pressure vessel such as the bicycle wheel of FIG. 1 in accordance with another embodiment;

FIG. 2B is a side sectional view of the pneumatic valve of FIG. 2A;

FIG. 2C is an enlarged sectional view of a portion of the pneumatic valve of FIG. 2B;

FIG. 3A-3M are views of a dust cap for a pneumatic valve in accordance with an embodiment;

FIG. 4 is a view of an embodiment of the dust cap of FIG. 3L and FIG, 3M coupled to a pump head;

FIG. 5A and FIG. 5B are views of a bicycle tire and an inner tube having a valve with the dust cap of FIGS. 3A-3M in accordance with an embodiment;

FIG. 6A-6J are views of a dust cap for a valve in accordance with another embodiment;

FIG. 7 is a view of the dust cap of FIG. 6A-6J coupled to a pump head;

FIG. 8A and FIG. 8B are views of a bicycle tire and an inner tube having a valve with the dust cap of FIGS. 6A-6J in accordance with an embodiment;

FIG. 9 is a side sectional view of a pump head adapter in accordance with an embodiment;

FIG. 10A-10E are views of a high flow Presta valve in accordance with an embodiment;

FIG. 11 is a view of the valve of FIG. 10A-10E coupled to a pump head;

FIG. 12A and FIG. 12B are views of a bicycle tire and an inner tube having a valve with the valve of FIG. 10A-10E in accordance with an embodiment;

FIG. 13A-13C are views of a pressure gauge that couples to a valve, such as the valve of FIG. 2A or FIG. 10A;

FIG. 14A-14D are views of a pump head with a sliding lock mechanism in accordance with an embodiment;

FIG. 15A and FIG. 15B are views of a bicycle tire and an inner tube coupled to a pump having the pump head of FIG. 14A-14D in accordance with an embodiment;

FIG. 16A-16G are views of valve with a dust cap in accordance with an embodiment;

FIG. 17 is a side sectional view of a pump head for use with the valve of FIG. 16A;

FIG. 18A-18C are views of a dust cap for use with the valve of FIG. 16A-16G in accordance with an embodiment;

FIG. 19A-19D are an embodiment of a valve with another sealing plug in accordance with an embodiment;

FIG. 20A-20C are view of a dust cap for use with the valve of FIG. 16A-16G in accordance with another embodiment;

FIG. 21 is an embodiment of a pump head for use with the valve of FIG. 19A-19C; and

FIG. 22A-22H are views of a valve and pump head arrangement having a seal external to the valve stem in accordance with an embodiment;

FIG. 23A-23H are views of a valve and pump head arrangement having a seal external to the valve stem and using an o-ring to secure the pump head in accordance with an embodiment; and

FIG. 24A-24H are views of a valve and pump head arrangement having a seal external to the valve stem and using an o-ring to secure the pump head in accordance with an embodiment;

### DETAILED DESCRIPTION

The present disclosure provides a novel valve and inflation system for pneumatic tires and related devices to improve ease of use. The described herein was designed to serve as an easy-to-use tire valve and valve coupler system, and is presented as an alternative to the longstanding tire valve systems. The new valve system allows the user to apply a valve coupler to a valve stem in one linear motion without the need for applying a clasp or latch to secure the valve coupler to the valve stem. The present disclosure allows for a smooth axial attachment of the valve coupler to the valve stem, and prevents leaks between the valve coupler and valve stem. Thus, the present disclosure provides significant improvement over the conventional valve system, providing a valve system that is mechanically more reliable, efficient and ergonomic for the user.

Embodiments of the present disclosure provide for accessories valve, such as a dust cap to protect the end of the valve. Still further embodiments of the present disclosure provide for an adapter that configures a prior art Schrader or Presta pump head to couple with the disclosed valve. Yet further embodiments provide for a rapid flow valve that increases the mass flow of air into a pressure vessel, such as a tubeless bicycle tire or an inner-tube type bicycle tire. Still further embodiments of the present disclosure provide for a pressure gauge that is configured to couple with the disclosed valve. Still further embodiments provide for a slide-lock pump head that facilitates the coupling of the pump to the disclosed valve.

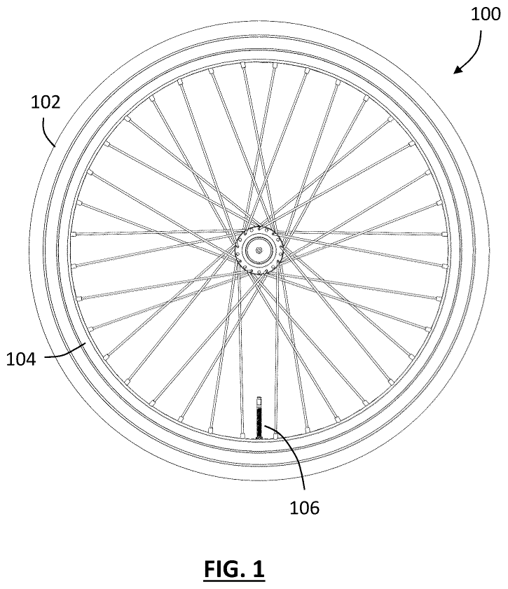

Pressure vessels are often used to contain a compressed gas, such as air. As shown in FIG. 1, an example of such a pressure vessel is a bicycle wheel 100 having a tire 102, a rim 104 and a valve 106. The wheel 100 may further include additional components, such as spokes, bearings or an axle for example. The wheel 100 may have an inner tube (not shown) disposed within the tire 102 that is coupled to the valve 106 and is configured to be inflated with a pressurized gas, such as air for example, to support the tire 102 during operation. The wheel 100 may also be a tubeless type where the tire 102 is sealingly coupled to the rim 104 to define the pressurized space that supports the tire in operation. In a tubeless type tire, the valve 106 is typically coupled to the rim 104. It should be appreciated that the embodiments disclosed herein may be use with either an inner-tube or a tubeless type tire configuration.

### Valve Description

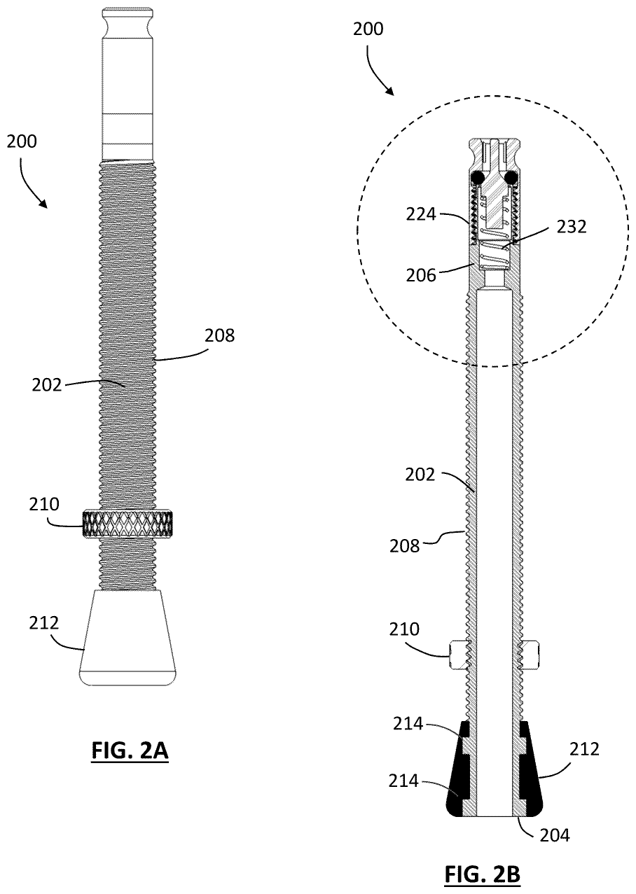

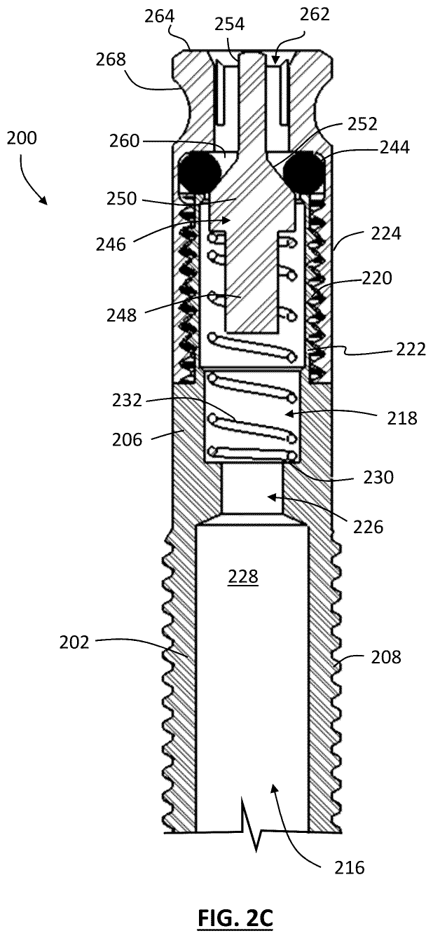

Referring now to FIG. 2A-2C, an embodiment of a pneumatic valve 200 for use on pressure vessel that does not include a tube. As mentioned herein, while the illustrated embodiment describes a valve for a tubeless tire, this is for example purposes only and the claims should not be so limited. Further, the embodiments described herein may be used with any of the valves described in commonly owned U.S. patent application Ser. No. 17/160,320 filed on Jan. 27, 2021, the contents of which are incorporated by reference herein.

The valve 200 includes an elongated generally cylindrical stem body 202 having a first end 204 and a second end 206. A threaded section 208 is centrally located between the first end 204 and the second end 206. The threaded section is configured to receive a rim nut 210. The rim nut 210 cooperates with a rim gasket 212 to sealingly couple the valve 200 to the rim 104 of the tubeless vessel.

Disposed on, or coupled to, the first end is the rim gasket 212. In the illustrated embodiment, the rim gasket is made from a rubber or elastomeric material that is deformable to allow the rim gasket 212 to seal against the rim of the wheel. In the illustrated embodiment, the rim gasket 212 includes a conical outer surface. In an embodiment, the rim gasket 212 is molded onto the stem body 202. The stem body 202 may optionally include one or more circumferential ribs 214 that facilitate in keeping the rim gasket in position at the first end 204.

The stem body 202 has a central passage 216 extends from the first end 204 to the second end 206. In the illustrated embodiment, the central passage 216 is coaxial with the stem body 202. In an embodiment, the central passage includes a first counter-bore or first cavity 218 extends inward from an end portion 220 of the second end 206. The end portion 220 may include a fastener feature, such as threads 222. The threads 222 engage and cooperate with corresponding threads on the cap member 224 to couple the cap member to the second end 206.

An intermediate passage 226 extends between the cavity 218 and the upper portion 228 of the central passage 216. In an embodiment, the intermediate passage 226 is a smaller diameter than the cavity 218 and the upper portion 228 so as to define a shoulder 230. The shoulder 230 is sized to support a biasing member, such as compression spring 232 that is at least partially disposed in the cavity 218. The second end 606 includes a second cavity that extends inward from an end surface. In an embodiment, the second cavity includes a first diameter portion at the end surface and a second diameter portion off set a predetermined distance from the end surface. In an embodiment, the first diameter portion is smaller than the second diameter portion. As a result, the interface of the two portions define a lip. In an embodiment, the lip may provide advantages in providing additional surface area on the end surface to engage the valve seat 244 while maintaining a desired thin wall thickness between the second diameter portion and the threads 222.

Disposed within the second cavity is a sealing plug 246. The compression spring bias' the sealing plug 246 against the valve seat 244. The sealing plug 246 is movable between a first or closed position in contact with the valve seat 244 (FIG. 2C) and a second or open position wherein at least a portion of the sealing plug 246 is displaced from the valve seat 244. When in the open position, the central passage 228 is fluidly coupled to a pump head (e.g. when the pressure vessel is being filled) or to the environment (e.g. when the user is removing air from the pressure vessel).

In an embodiment, the sealing plug 246 includes a lower portion 248 that is sized to be received within the inner diameter of the compression spring 232. Extending from the lower portion 248 is a middle portion 250. The middle portion 250 has an outer diameter that this larger than an inner diameter of the valve seat 244. The middle portion 250 further includes a conical portion 252 that transitions the outer diameter of the middle portion 250 to a upper or pin portion 254. The pin portion 254 has a diameter that is smaller than the valve seat 244. It should be appreciated that the conical portion 252 engages the valve seat 244. It should further be appreciated that during an air filling operation the pin portion 254 is engaged by the inflation pin in the pump head, which causes the sealing plug 244 to translate and the spring 232 to compress.

The cap member 224 includes an internal bore having threads. The threads cooperate with threads 222 to couple the cap member 224 to the stem body 202. In an embodiment, the threads do not extend the full depth of the bore resulting in a cavity 260 being disposed at the end of the bore. The cavity 260 is sized to receive the seat valve 244 such that when the cap member 224 is coupled to the stem body 202, the valve seat 244 is sealing disposed between the end of the bore and the end surface of the stem body. As a result, the valve seat 244 also seals any gap between the threads to prevent the leakage of air. The cap member 224 further includes a pin passage 262 between an end surface 264 and the cavity 260. In an embodiment, the pin passage 262 may include tool features such as slots sized and positioned to receive a hexagonal tool (e.g. an Allen wrench) that allows the user to tighten the cap member 224 to the stem body 202. Finally, the cap member 224 includes a curved slot 268 that extends circumferentially (i.e. a circumferential concavity) about an outer surface 670. The curved slot 268 cooperates with features, such as a bearing, a protrusion, or an o-ring on the pump head to removably couple the pump head to the valve 200. An example of such a pump head is described in the aforementioned U.S. patent application Ser. No. 17/160,320.

### Dust Cap and Presta/Sclaverand Pump Adapter

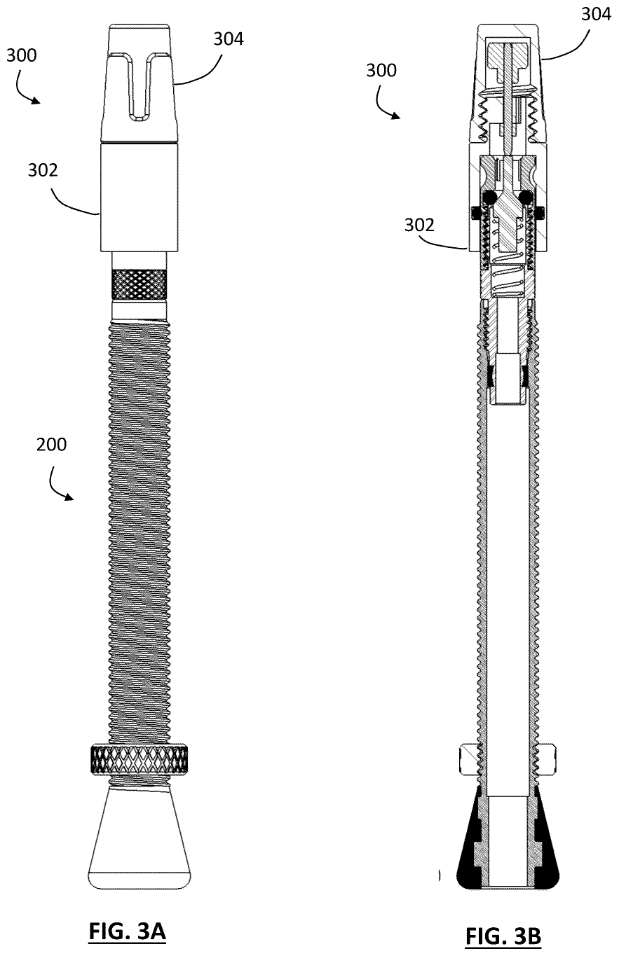

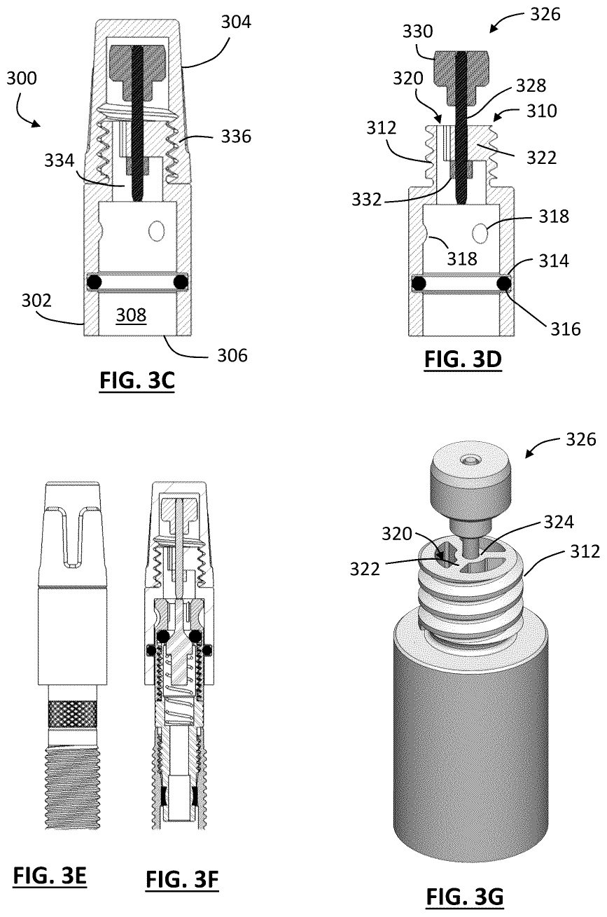

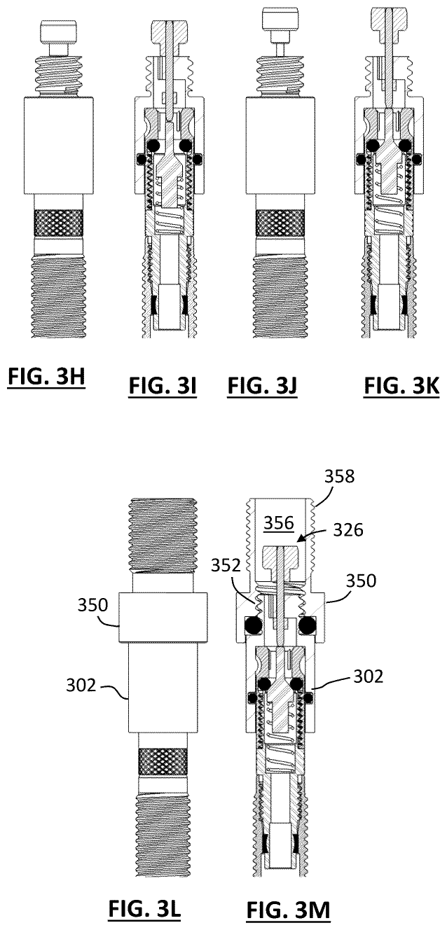

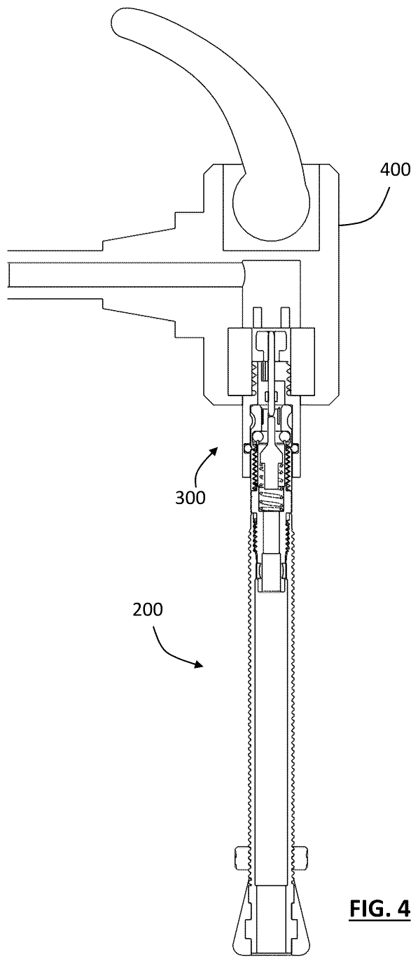

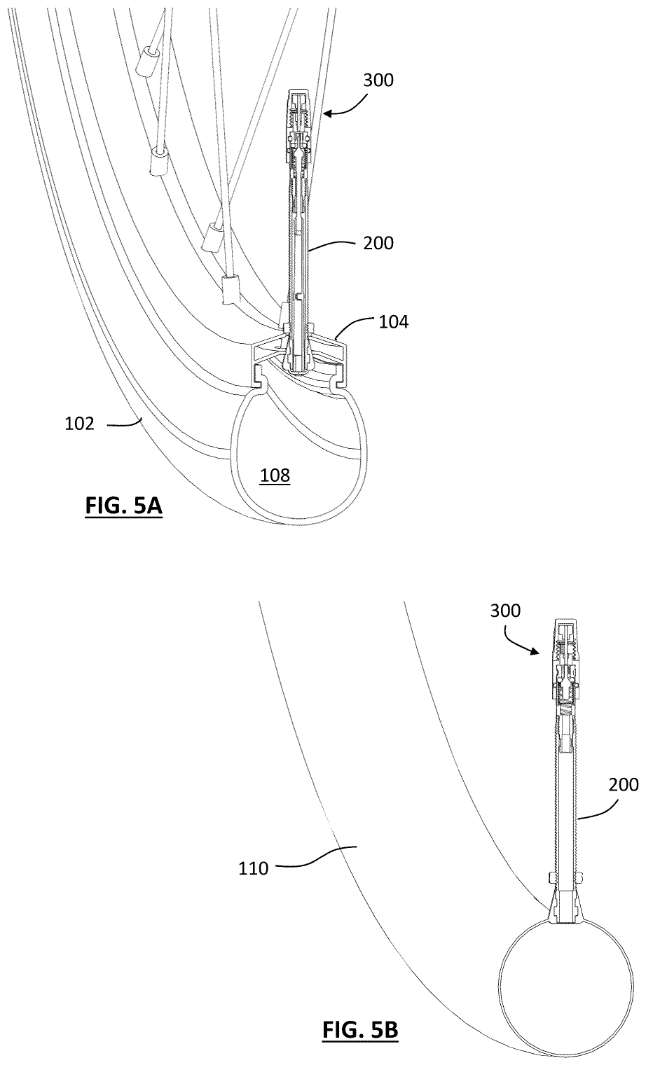

Referring now to FIGS. 3A-3M, an embodiment is shown of a dust cap 300 for protecting a valve 200. The dust cap 300 includes a body 302 and a cap 304. The body 302 includes a bottom side opening 306 and cavity 308 configured to receive, hold, and sealingly couple to the cap member 224 of valve 200. The body 302 further includes an opposing end 310 with a threaded fastener 312 that is sized and configured to interface with and allow for an airtight seal with a Presta (aka Sclaverand) style pneumatic pump-head fitting. Within the cavity 308 is a slot 314 sized to receive a gasket or o-ring type seal 316. In other embodiments, the seal 316 may be positioned on the end of the cavity 308 and form a face compression seal with the valve. A plurality of hemispherical protrusions 318, ball bearings, other protruding geometries, or an o-ring circumscribing and extending into the inner diameter of the cavity 308. The position and size of the protrusions 318 anare configured to engage the slot 268 to allow the body 302 to be removably coupled to the valve 200.

Extending from the cavity 308 and through the end 310 are a plurality of perforations 320. The perforations 320 are separated by walls 322 that extend radially from a center portion 324. The perforations 320 fluidly couple the end 310 (and the environment when the cap 304 is not installed) to the pin passage 262.

A valve actuating element 326 is provided that is comprised of a rod 328 and a head 330 is located in a centered hole in center portion 324 and is allowed to freely move/translate axially to a degree sufficient to engage the pin portion 254 of sealing plug 246. By moving the actuating element 326 towards the valve 200, the sealing plug 246 is moved from the first position (engaged with the valve seat) shown in FIG. 3H and FIG. 3I to a second displaced position shown in FIG. 3J and FIG. 3K to fluidly couple the end 310 to the central passage 316. Upon depression of the actuating element head 330 by a complimentary pump-head 400 of either Presta or Schrader configuration, fluid communication between the pressurized vessel (e.g the tire inner-tube or the pressurized space in a tubeless tire) and the pump is established. Alternatively, an end user may press upon the actuating element 326 with a finger to depressurize the connected vessel. In an embodiment, an element, such as an o-ring or gasket 332 is coupled to the rod 328 to limit the amount of travel of the actuating element 326 in a direction away from the valve 200.

The cap member 304 includes a cavity 334 having a threaded portion 336 that is sized to engage and couple with the threads 312. The cavity 334 is sized to enclose the actuating element 326 when the threaded portion 336 is fully engaged. It should be appreciated that this provides advantages in protecting the end of the valve 200, such as when the bicycle that the wheel 100 is attached is being used.

In an embodiment, the body 302 provides further advantages in allow the coupling of an adapter 350 allows for an airtight interface with a Schrader-style pump-head. In an embodiment, the adapter 350 includes a threaded portion 352 configured to engage with the threads 312 on body 302. A seal, such as o-ring 354 is disposed within an end cavity of the adapter 350 to form a seal between the body 302 and the adapter 350. The adapter 350 further includes a second cavity 356 that is sized to allow the engagement mechanism of the Schrader-style pump-head to engage the actuating element 326. The adapter 350 further includes a threaded element 358 on an end 360 opposite the body 302.

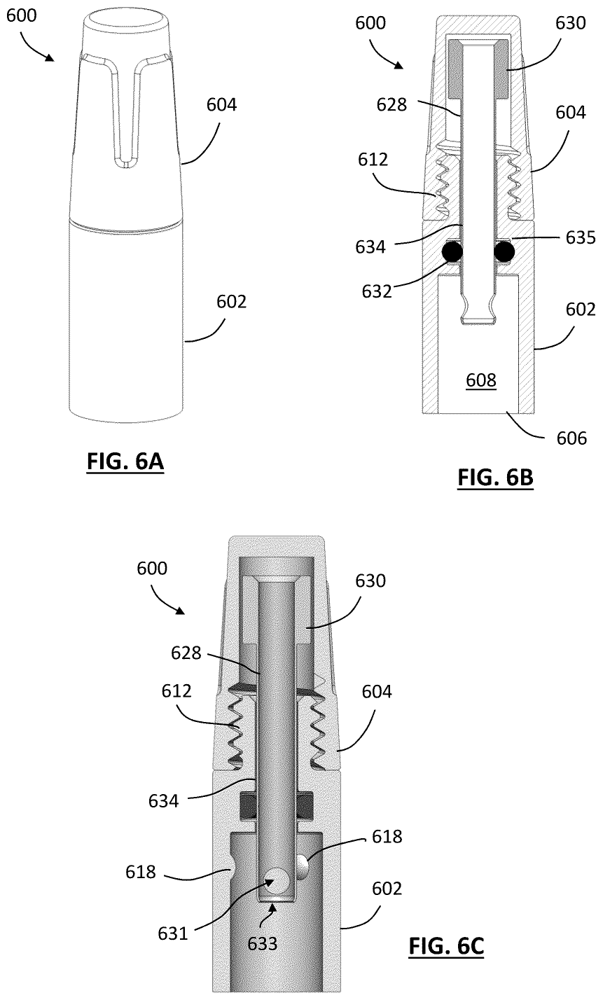

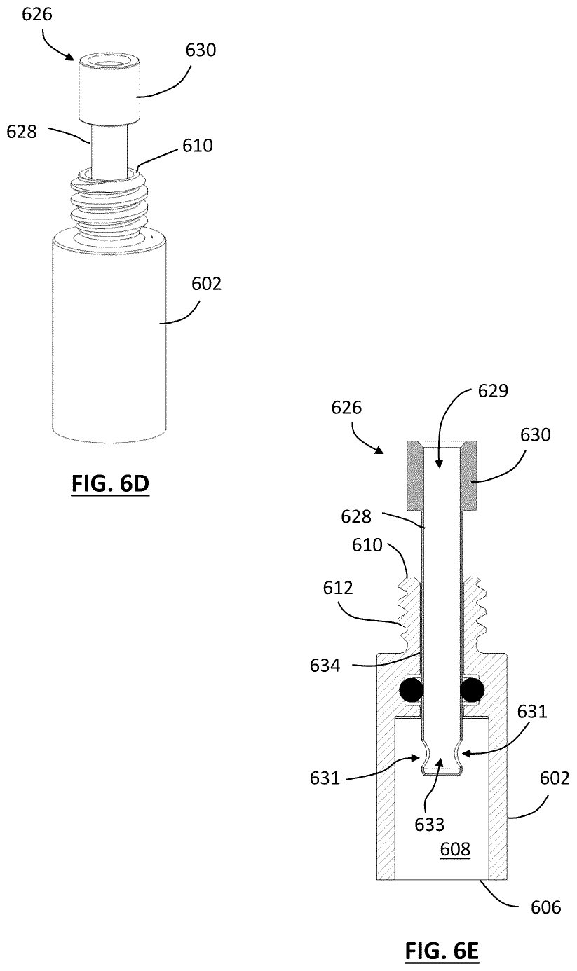

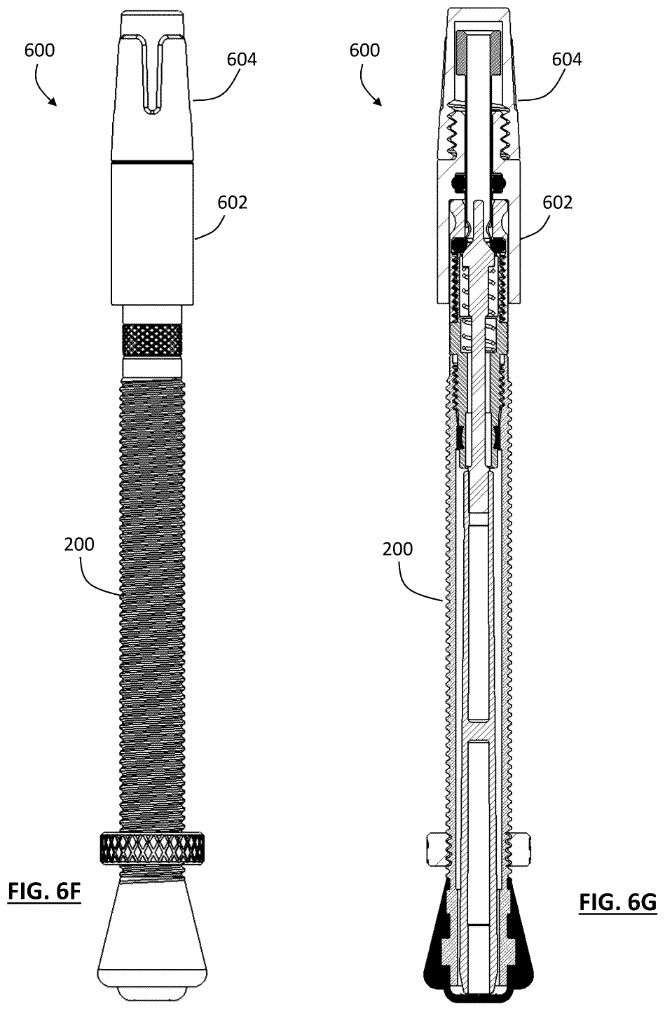

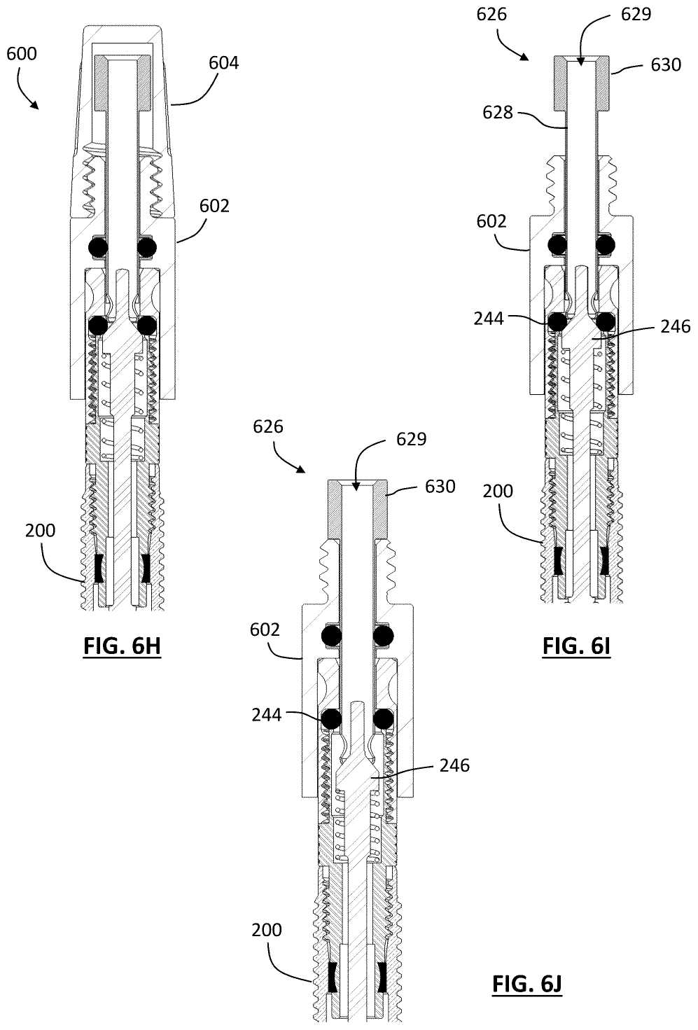

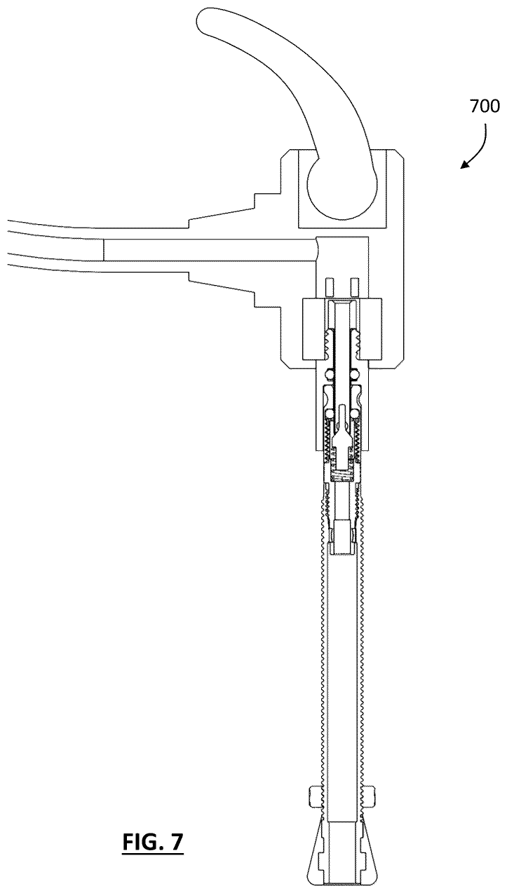

Referring now to FIGS. 6A-6J, another embodiment is shown of a dust cap 600 having a body 602 and a cap 604. In this embodiment, the body 602 includes a bottom opening 606 and a cavity 608. Similar to the body 302, the body 602 include semi-spherical protrusions 618 or similar features that allow the body 602 to engage the slot 268 and be removably coupled to the cap member 224. A through hole 634 extends from a bottom of the cavity 608 through an end 610. The hole 634 includes a slot 635 that is sized to receive a seal, such as a gasket or o-ring 632. The body 602 further includes a threaded element 612 that allows the cap 604, a Presta style pump head 700 (FIG. 7) or Schrader style adapter to be coupled thereto in the same manner as was described with respect to the embodiment of dust cap 300.

Extending through the hole 634 is an actuating assembly 626 that includes a hollow rod 628 and a head 630. In this embodiment, the rod 628 includes a through hole or passageway 629. On a distal end from the head 630, the rod 628 has a plurality of transverse holes 631 and a bottom or axial opening 633.

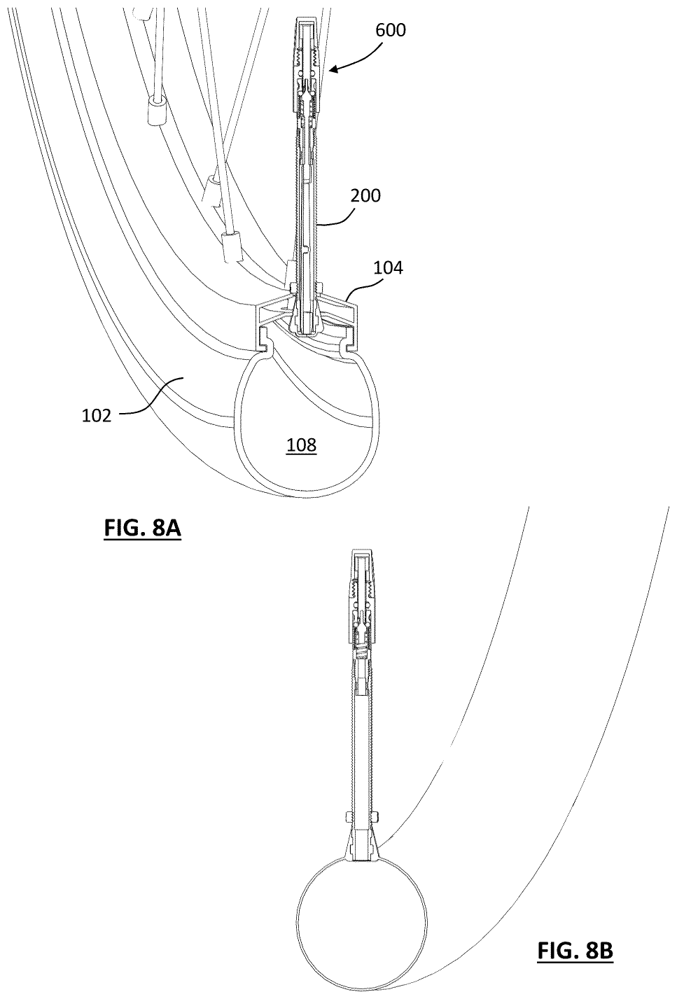

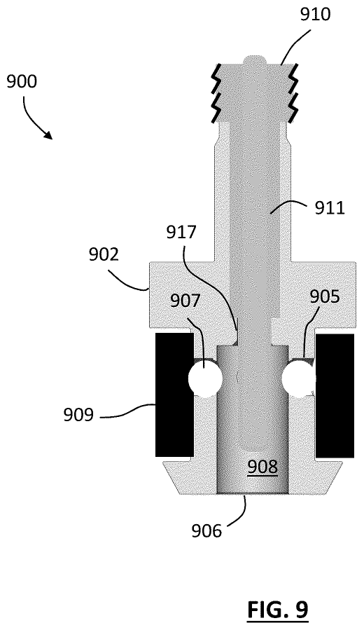

As best seen in FIG. 6G-FIG. 6J, when the body 602 is coupled to the valve 200, the end of the rod 628 fits into the pin passage 262 of the cap member 224. In an embodiment, the end of the rod 628 rests or is in contact with the valve seat 244 when the sealing plug 246 is in the closed position with the pin portion 252 extending into the passageway 630. When the head member 630 is actuated (e.g. moved toward the valve 200), the outer diameter of the rod 628 slides past the valve seat 244 and engages the conical portion 250 of the sealing plug 246 causing the sealing plug to axially translate and disengage from the valve seat 244 (FIG. 6J). Upon disengagement of the sealing plug 246, the central passageway 216 of the stem body 202 is fluidly coupled to the passageway 629. When the body is coupled to a pump head, such as pump head 700 for example, pressurized air may pass from the pump head, through the dust cap 600 through the valve 200 and into a pressure vessel, such as the space 108 in a tubeless tire 102 or an inner-tube 110 in a tube type tire (FIG. 8A, FIG. 8B).

It should be appreciated that the valve 200 illustrated in FIGS. 6A-6J is a double seal type valve that provides advantages in preventing liquid or aerosol sealant that is deposited in the space 108 from clogging our fouling the valve 200. Valves 200 of this type are described in the aforementioned U.S. patent application Ser. No. 17/160,320.

### Pump Head Adapter

It should be appreciated that currently Schrader-type and Presta-type pump heads are commonly available. As such, it may be desirable for the user to have an adapter 900 that allows the connection of a valve 200 to a Schrader-type and Presta-type pump head. In this embodiment, the adapter 900 includes a body 902 having a bottom opening 906 and first cavity 908. The body 902 includes a plurality of holes 905 that have a first diameter on an outside surface of the body and a smaller second diameter on a surface of the cavity 908. The holes 905 are sized to receive ball bearings 907 or other spherically shaped members. The hole 905 diameters are sized to allow the bearings 907 the extend partially into the cavity 908. The holes 905 and bearings 907 are sized and positioned to engage the slot 268 on the cap member 224 when the adapter 900 is coupled to the valve 200. An elastic sleeve 909 extends about the periphery of the bearings 907 to bias the bearings into the cavity 908.

The body 902 further includes a second cavity 911 that extends inward from a second end 910. The second end 910 further includes threaded elements 912 that are sized to couple with a Schrader-type or Presta-type pump head. It should be appreciated that when the adapter 900 is coupled to a pump head, the pump head is fluidly coupled to the second cavity 911. The second cavity 911 is fluidly coupled to the first cavity 908 via an axial passageway 917. A rod 928 extends through the second cavity 911 and passageway 917 and at least partially into the first cavity 908. The rod 928 has an end positioned to engage the pin portion 252 and displace the sealing plug 246 from the valve seat 244 when the adapter 900 is coupled to the valve 200. It should be appreciated that this allows the Schrader-type or Presta-type pump head to be coupled to the valve 200.

### Rapid Flow Valve

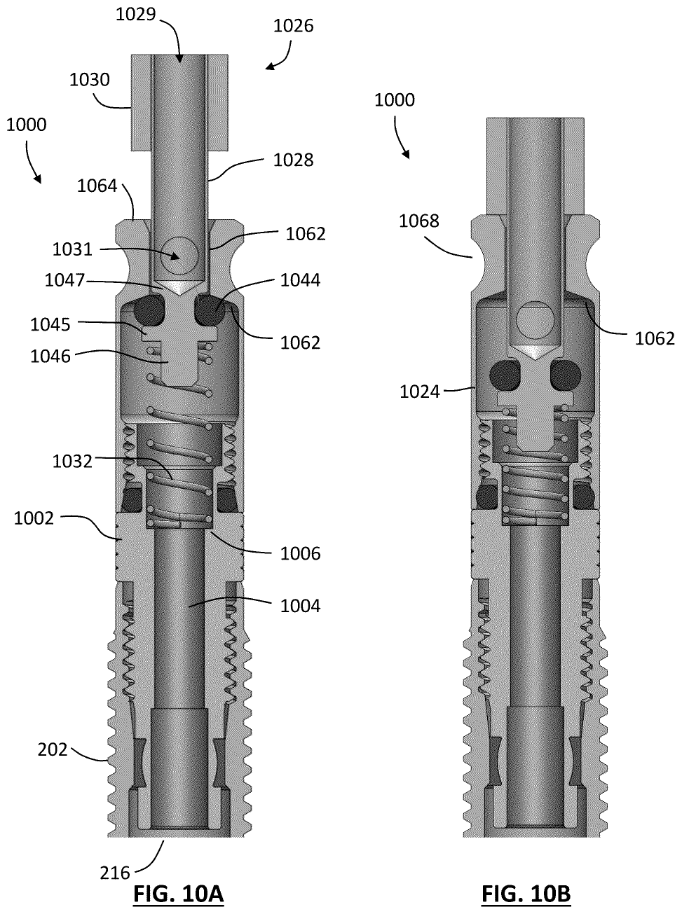

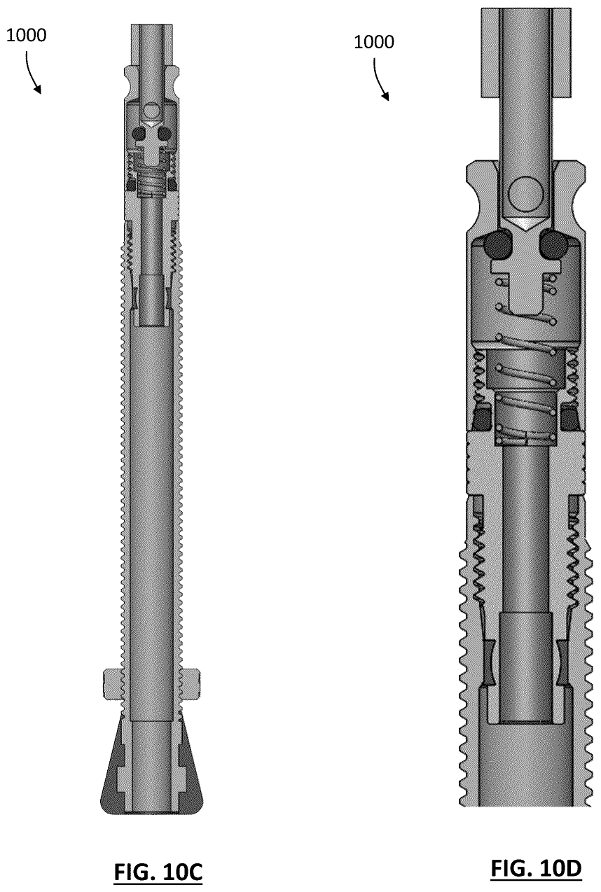

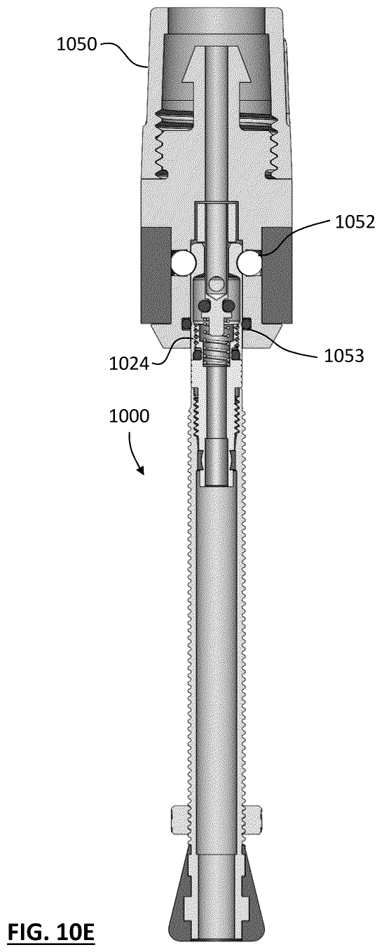

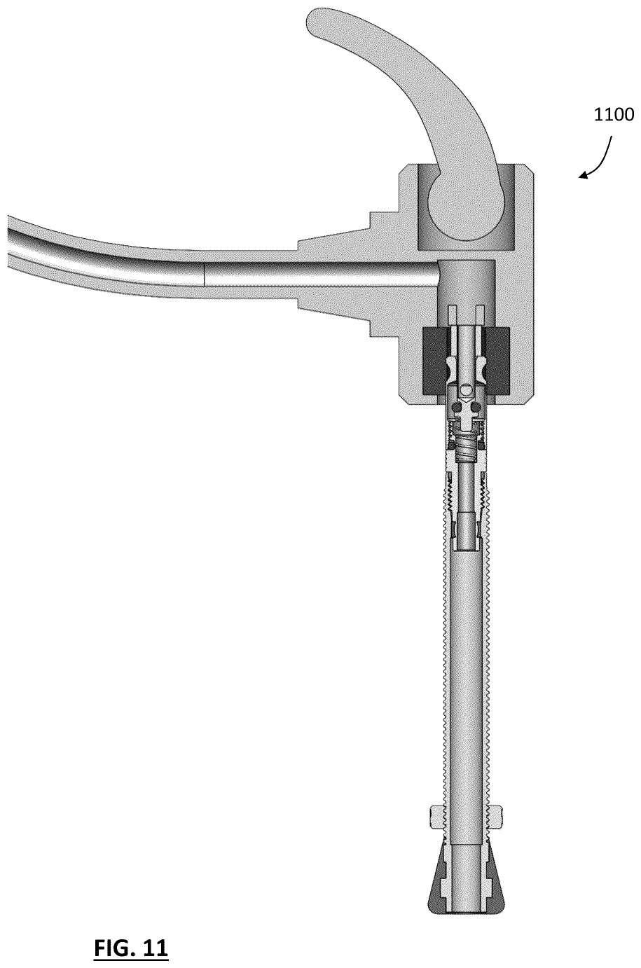

Referring now to FIGS. 10A-10E an embodiment is shown of a high flow Presta type valve 1000. As used herein, a high flow valve is one that allows for mass transfer of air through the valve that is between 2-10 times that of a normal Presta valve. In this embodiment, the valve 1000 includes a body 1002 that couples to the stem body 202. The body 1002 includes a central passageway 1004 that is stepped from a first diameter to a second diameter to form a shoulder 1006. The shoulder 1006 supports a biasing member, such as compression spring 1032. The compression spring 1032 bias a sealing plug 1046 towards an end 1062 of a cavity in the cap member 1024. The cap member 1024 includes a circumferential slot 1068 that receives an element 1052 on the pump head 1050 (FIG. 10E) to removably couple the pump head to the valve 1000.

In an embodiment (FIG. 10E), the pump head 1050 includes a sealing element, such as an o-ring 1053 for example, that engages with an outside diameter/surface of the cap member 2024. It should be appreciated that the o-ring 1053 reduces the risk of air leakage during operation.

The sealing plug 1046 includes a flange 1045 that engages the spring 1032 on a first side. The sealing plug 1046 further includes a projection 1047 on an end opposite the spring 1032. In an embodiment, the projection 1047 has a conical surface. The flange 1045 and projection 1047 cooperate to form a slot that is sized to receive a seal, such as a gasket or o-ring 1044. In an embodiment, the end surface of the sealing plug 1046 opposite the spring 1032 has a conical recess. A pin passage 1062 extends from the end 1062 through an end surface 1064. When the valve 1000 is in a closed position, the seal 1044 engages the end 1062 and seals the pin passage 1062 from the central passageway 1004.

In the illustrated embodiment, the valve 1000 is a Presta-type valve that includes an actuating element 1026 having a rod 1028 and a head 1030. In an embodiment, the rod 1028 is integral with the sealing plug 1046. A central hole 1029 extends axially through the rod 108 and has transverse hold 1031 at an end adjacent the seal 1044. With the sealing plug 1044 is actuated axially towards the valve 200, the transverse openings move past the end 1062 into the cavity in the cap member 1024 to fluidly couple the central hole 1029 to the central passageway 1004. It should be appreciated that in this embodiment, the seal 1044 moves with the sealing plug 1046.

Since the seal 1044 can be smaller than the valve seat 244, a larger flow path may be formed between the central hole 1029 and the central passageway 1004.

It should be appreciated that the valve 1000 may be adapted to a Schrader-type of Presta-type pump head 1100 (FIG. 11) in a similar manner as the other embodiments described herein.

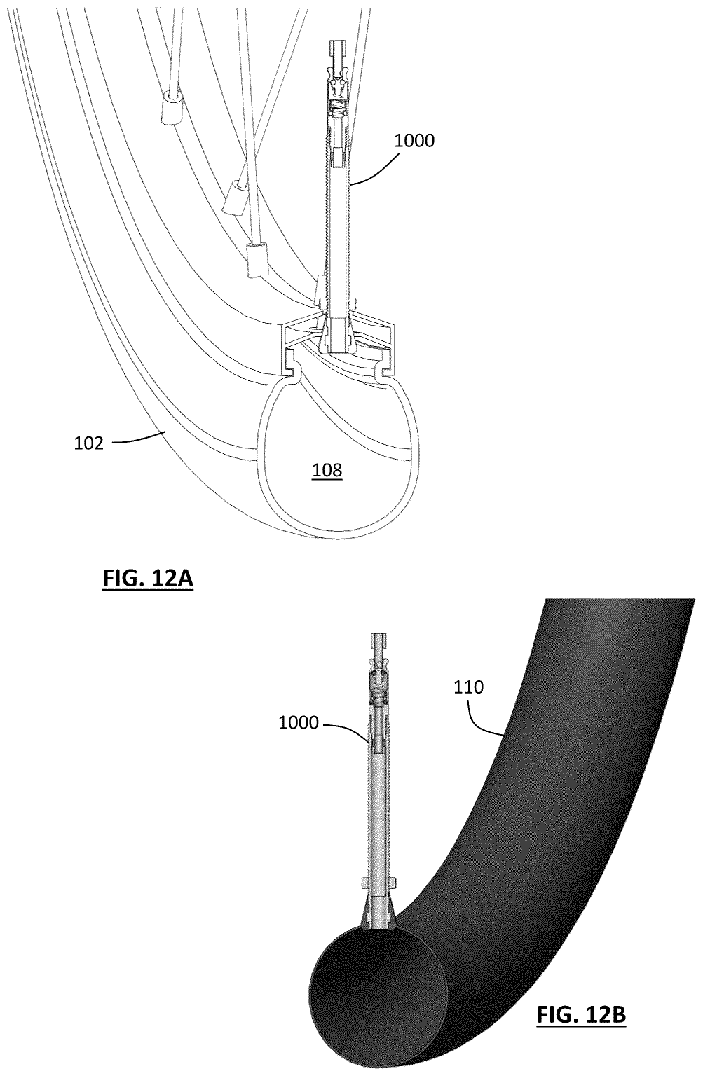

In operation, the user couples the pump head 1050, 1100 to the cap member 1024 and actuates the actuating element 1026 to displace the seal 1044 and open a fluid pathway from the pump head 1050, 1100. This allows pressurized air to flow into the pressure vessel, such as space 108 in a tubeless tire or an inner-tube 110 (FIG. 12A, FIG. 12B).

### Pressure Gauge

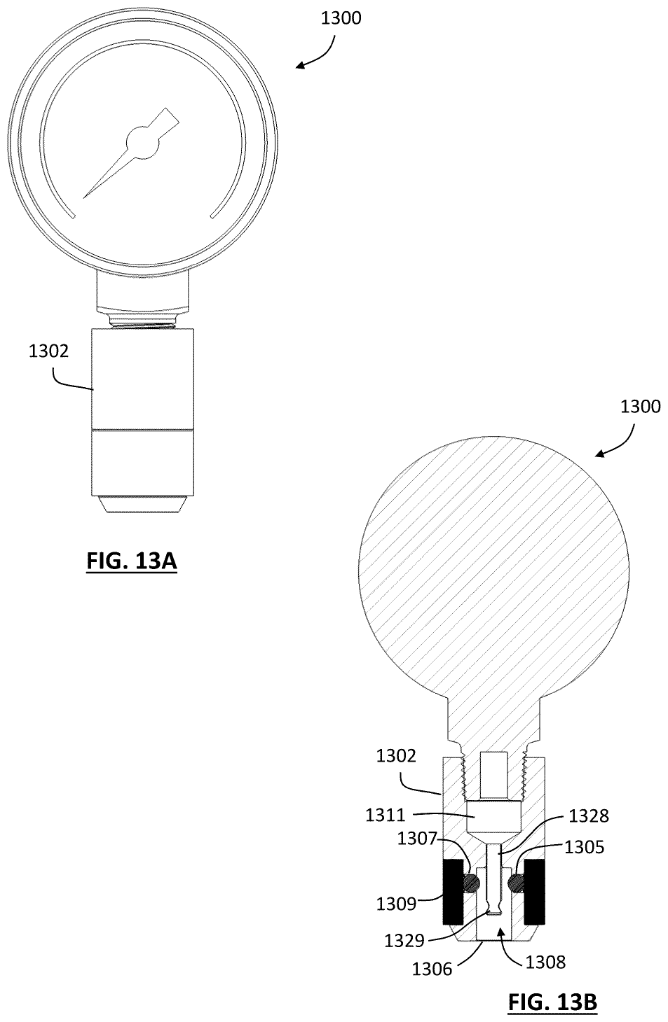

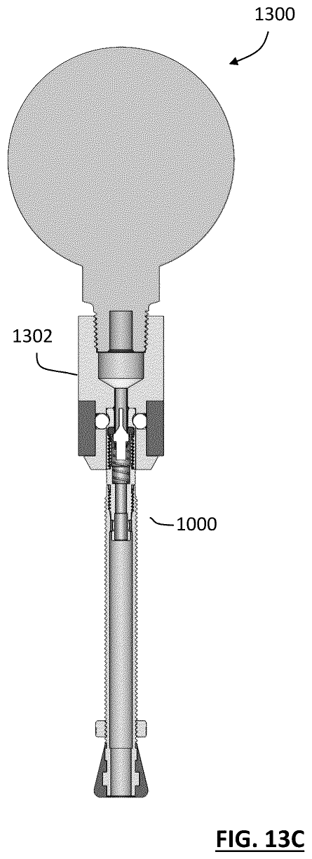

It should be appreciated that a user of device that includes valve 200 may desire to check the pressure within the pressure vessel, such as wheel 100 for example. Referring now to FIG. 13A-13C, an embodiment is shown of a pressure gauge 1300 that is configured to provide a pressure level measurement of a gas in a pressure vessel. The pressure gauge 1300 may use any known type of pressure measurement device, such as a manometer-style or a Bourbon tube style pressure gauge for example. The pressure gauge 1300 includes a body 1302 that may be constructed in a similar manner to the adapter 900 for example. The body 1302 includes an opening 1306 to a cavity 1308. The body includes a plurality of holes 1305 that are sized to receive bearings 1307 that extend at least partially into the cavity 1308. An elastic sleeve 1309 extends about the periphery of the bearings 1307 to bias the bearings into the cavity 1308.

A hollow rod 1328 is coupled to the body 1302 and extends into the cavity 1308. The rod 1328 includes a plurality of transverse holes 1329 positioned within the cavity 1308. The rod 1328 fluidly couples the cavity 1308 with a chamber 1311. The chamber 1311 is in operable communication with the pressure measurement mechanism. When the pressure gauge 1300 is coupled to a valve, such as valve 1000 (FIG. 13C) for example, the rod 1320 engages the sealing plug and disengages the seal to fluidly couple the pressure vessel to the pressure gauge mechanism, allowing the pressure in the pressure vessel to be measured.

### Slide-Lock Pump Head

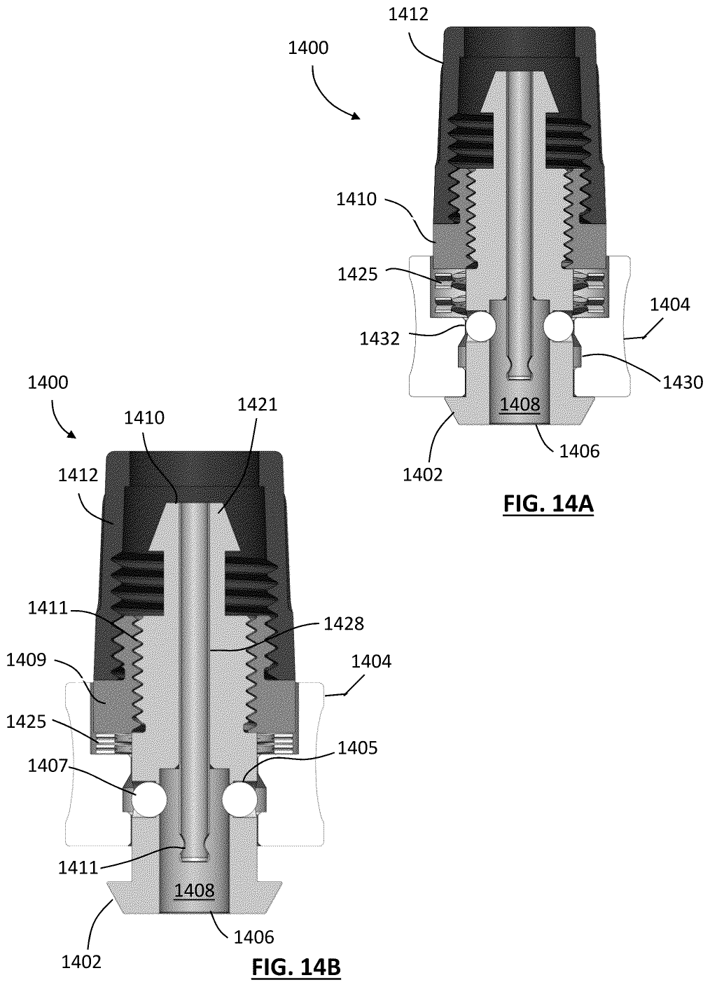

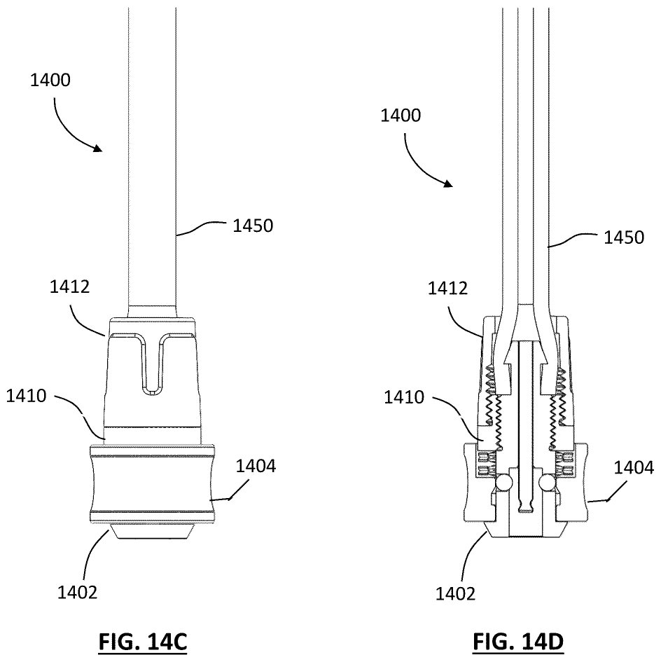

Referring now to FIG. 14A-14D, an embodiment is shown of a pump head 1400 having a sliding lock mechanism. In this embodiment, the pump head 1400 has a body 1402, a movable actuator 1404, an intermediate member 1409 and a hose clamp 1412. The body 1402 includes an end opening 1406 and a cavity 1408. A plurality of holes 1405 extend through the side of the body 1402 into the cavity 1408. Similar to the adapter 900, the holes 1405 have a varying diameter with the diameter at the cavity 1408 being smaller than the largest diameter of bearings 1407 or the spherical members. In this way, the bearings 1407 are able to extend at least partially into the cavity 1408. A hollow rod 1428 extends through the body 1402 and at least partially in the cavity 1408. The rod 1428 includes at least one transverse hole 1411 that allows the end 1410 to be fluidly coupled to the cavity 1408.

The body 1402 further includes a coupling feature 1421 such as a tapered barb for example on an end opposite the opening 1406 to allow the pump head 1400 to couple with a hose 1450. The intermediate member 1409 is coupled to the body 1402 and includes a threaded element 1411 that allows the hose clamp 1412 to be removably coupled to the pump head 1400.

The actuator 1404 is disposed about the body 1402 and includes an inner slot 1430. In an embodiment, one side of the slot 1430 is angled. The slot 1430 is disposed to be aligned with the bearings 1407 when the actuator is in the released position (FIG. 14B). The actuator 1404 further includes a wall portion 1432 adjacent the slot 1430. The wall portion 1432 is positioned to be adjacent to the bearings 1407 when the actuator is in the engaged position (FIG. 14A).

A biasing member, such as a Belleville spring 1425 for example, is disposed between the actuator member 1404 and the intermediate member 1409 and bias the actuator member 1404 into the engaged position. In operation, the user moves the actuator member 1404 include the disengaged position (FIG. 14B) and slides the body 1402 onto the valve such that the cap member 224 is disposed in the cavity 1408. When in the disengaged position, the bearings 1407 are aligned with the slot 1430 so that the bearings 1407 move away from the cavity 1408 when contacted by the end of the cap member 224 allowing the pump head 1400 to be easily positioned on the valve. When the actuator member 1404 is released by the user, the biasing member 1425 moves the actuator member 1404 towards the valve. As the bearings 1407 contact the side of the slot 1430, the bearings are moved towards the cavity 1408 to engage the slot 268 in the cap member 224. The wall portion 1432 holds the bearings 1407 engaged with the slot 268 until the actuator member 1404 is retracted to the disengaged position, whereupon the bearings 1407 are free to move and will disengage the slot 268 when the pump head 1400 is moved away from the valve.

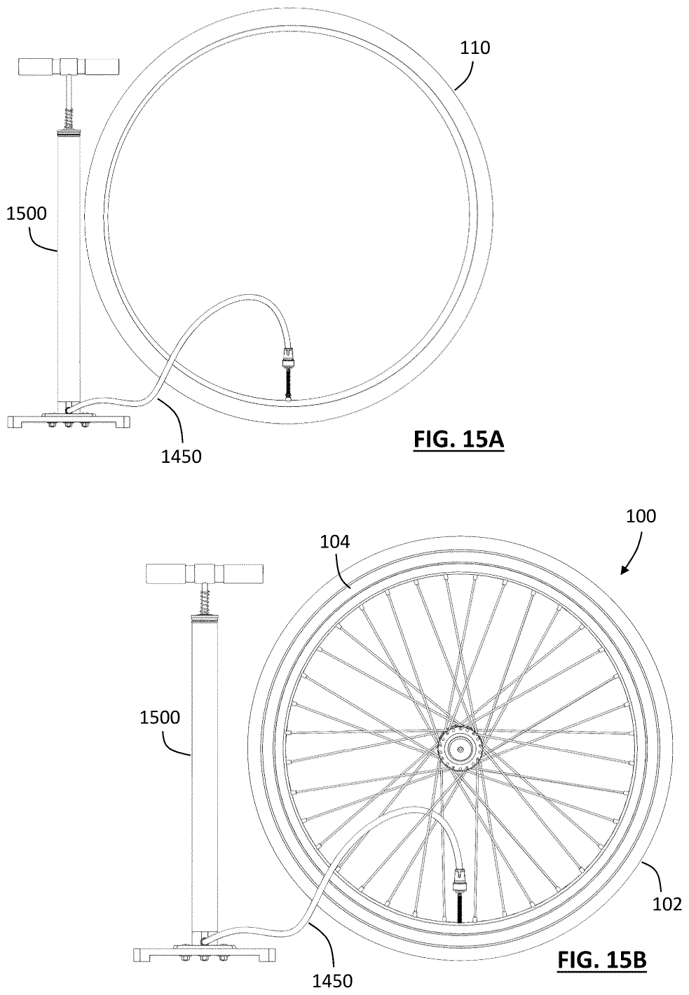

Referring to FIG. 15A and FIG. 15B a pump 1500 is shown having a hose 1450 coupled to the pump head 1400 to allow the adding of pressurized air to a tubeless tire 100 or an inner tube 110. It should be appreciated that while embodiments herein illustrate the hose 1450 as extending axially from the pump head 1400, this is for exemplary purposes and the claims should not be so limited. In other embodiments, the hose 1450 may exit the pump head at a 90 degree angle from the axis of the pump head or on an angle between 0-90 degrees.

### Inline Dust Cap

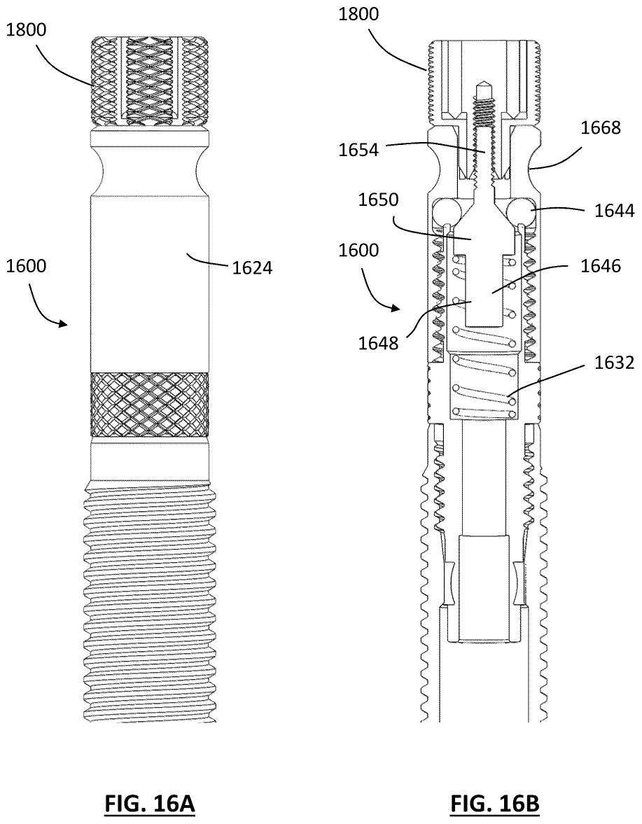

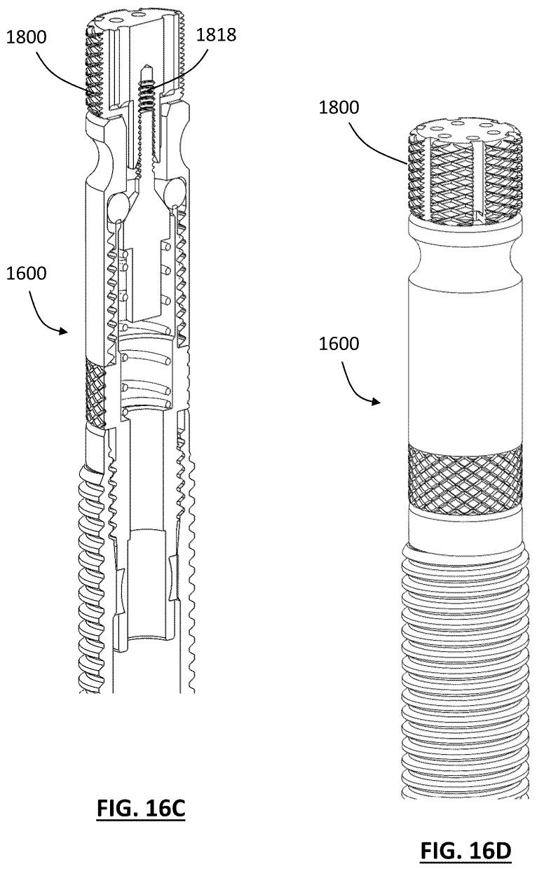

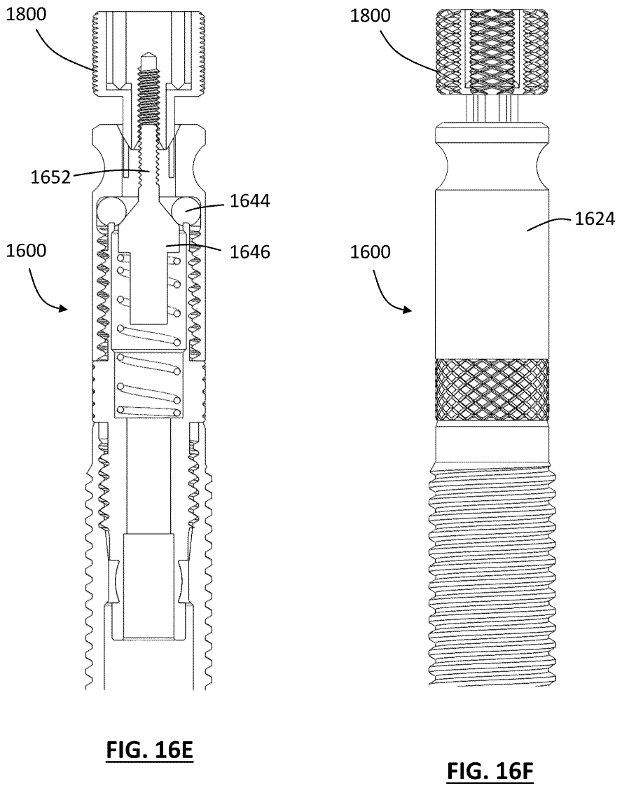

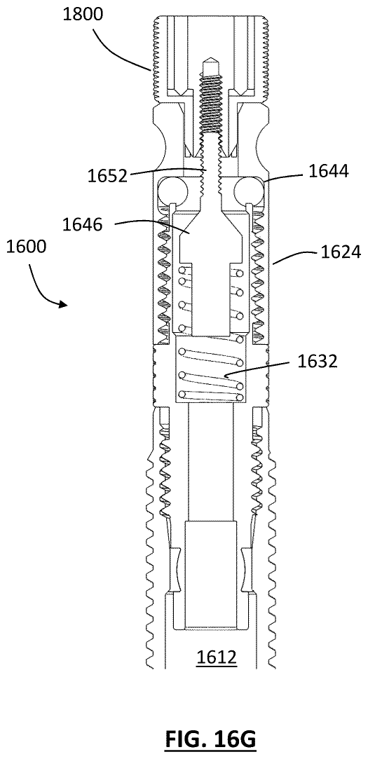

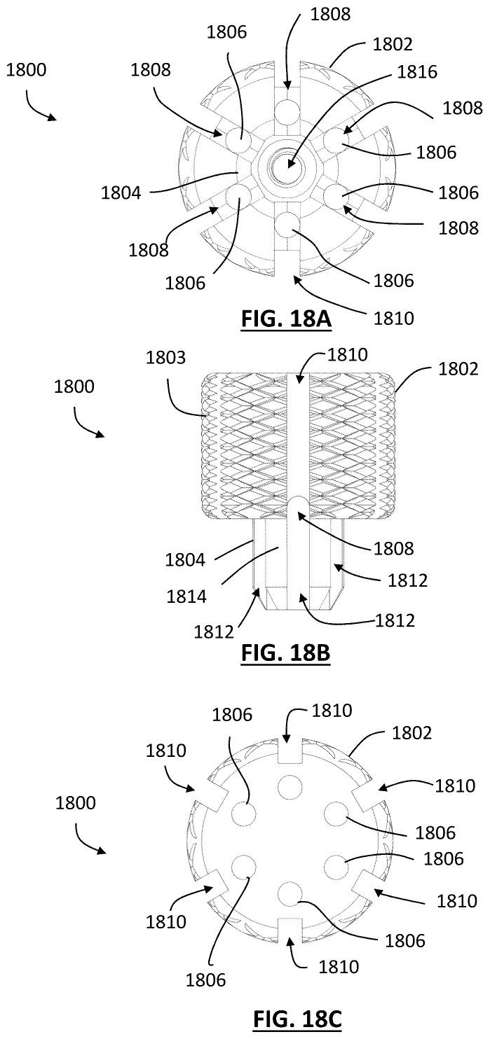

Referring now to FIGS. 16A-16G and FIGS. 18A-18C, an embodiment is shown of a valve 1600 having a threaded dust cap 1800. The valve 1600 is constructed in a similar manner to valve 200 in that a biasing member 1632 biases a sealing plug 1646 against a valve seat 1644. The sealing plug 1646 is similar to sealing plug 246 having a lower portion 1648, a middle portion 1650 with a conical section, and a pin portion 1654. In this embodiment, however, the pin portion 1654 includes threaded elements on its outer surface as will be discussed in more detail below. The valve 1600 further includes a cap member 1624 having a cavity that receives the valve seat 1844 and the sealing plug 1646. A pin passage extends from the cavity to the upper surface in the same manner as cap member 224. The cap member 1624 further includes a circumferential concavity 1668 to engage and secure the pump head as is described herein.

Coupled to the valve 1600 is a threaded dust cap 1800. As best seen in FIGS. 18A-18C, in this embodiment, the dust cap 1800 includes an upper portion 1802 and a lower portion 1804. The upper portion 1802 includes an outer surface 1803 that may have a diameter substantially the same size as the cap member 1624. It should be appreciated that the upper portion 1802 may also have a larger or smaller diameter. In an embodiment, the outer surface is knurled to facilitate the user gripping the dust cap 1800. The upper portion 1800 further includes a plurality of holes 1806 that extend through the upper portion 1802 and fluidly communicate with radially extending slots 1808. In the illustrated embodiment there are six holes 1806 and six slots 1808. The upper portion 1802 further includes a plurality of slots 1810 extending along the outer surface 1803. In an embodiment, the slots 1810 extend in parallel to the holes 1806. The slots 1810 intersect and are in fluid communication with the radially extending slots 1808.

The lower portion 1804 further include a plurality of slots 1812 that extend along an outer surface 1814. The outer surface has an outer diameter that is sized to fit within the pin passage of the cap member. The slots 1812 extend through the bottom of the lower portion 1804. The slots 1812 further intersect with and are in fluid communication with the radially extending slots 1803. As will be discussed in more detail, the slots 1812 cooperate with the radial slots 1808, the slots 1810 and the holes 1806 to define a fluid pathway during operation.

The dust cap 1800 further includes a central hole 1816 that include threaded elements 1818 (FIG. 16C) that engage and cooperate with the threaded elements of pin portion 1852. In an embodiment, the central hole 1816 extends from the bottom surface of the lower portion 1804 through the lower portion 1804 and at least partially into the upper portion 1802.

Referring back to FIGS. 16A-16G with continuing reference to FIGS. 18A-18C. In this embodiment, the lower portion 1804 of dust cap 1800 is inserted into the pin passage of the cap member 1624 with the hole 1816 engaging the pin portion 1654. The dust cap 1800 is rotated to engage the threads of hole 1816 with the threads on pin portion 1654. This rotation is continued until the lower surface of the upper portion 1802 of the dust cap 1800 contacts the upper surface of the cap member 1624. It should be appreciated that any additional rotation of the dust cap 1800 will cause the sealing plug 1646 to move towards the dust cap 1800. It should be further appreciated that this provides advantages in mechanically securing the conical surface 1650 of sealing plug 1646 against the valve seat 1644 in addition to the biasing force of biasing member 1632. The dust cap 1800 further provides advantages in that it may be easily installed and removed by the user.

In some embodiments, it may be desirable to allow the user to either add compressed air to the pressure vessel (e.g. an inner tube or a tubeless bicycle tire) without removing the dust cap. In these embodiments, the user rotates the dust cap 1800 to separate the upper portion 1802 from the top surface of the cap member 1624 (FIG. 16E, FIG. 16F. It should be appreciated that in this configuration, the dust cap 1800 is still coupled to the pin portion 1652 and the sealing plug 1646 is engaged with the valve seat 1844 so the pressure vessel remains sealed and pressurized.

When the user wants to remove pressurized air from the pressure vessel, the user simply presses downward (e.g. towards the valve 1600). This causes the lower portion 1804 to slide further into the cap member 1624 pin passage, overcoming the biasing force of the biasing member 1632 and causing the sealing plug 1646 to separate from the valve seat 1644 (FIG. 16G). It should be appreciated that the central passage 1612 of the stem body 1602 is then in fluid communication with the pin passage of cap member 1624. Since the slots 1812 and radial slots 1808 are in fluid communication with the holes 1806 and the slots 1810, one or more fluid pathways are formed from the pin passage of the cap member 1624 to the environment. Thus pressurized air may be released from the pressure vessel. When the desired amount of air is released, the user simply releases the dust cap 1800 and the sealing plug 1646 once again engages the valve seat 1644 to stop the flow of air. The user may then rotate the dust cap 1800 to once again tighten against the cap member 1624.

When the user wants to add pressurized air, a pump head 1700 is disposed over the outer surface 1803 of the dust cap 1800 and is coupled to the cap member 1624. The user may then actuate the pump head lever, causing the cap member 1800 to translate and move the conical surface of the sealing plug 1646 away from the valve seat 1644. Pressurized air may then flow through the holes 1806, the slots 1810 and then through the radial slots 1806 and lower portion slots 1812 into the valve 1600 and the pressure vessel.

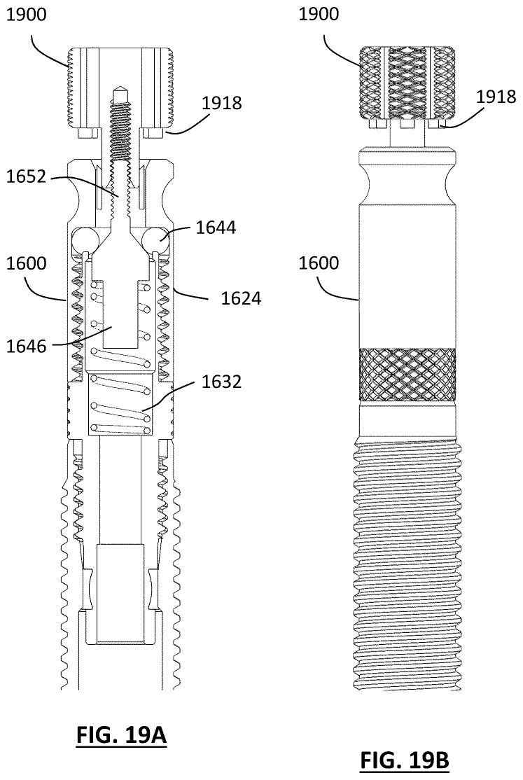

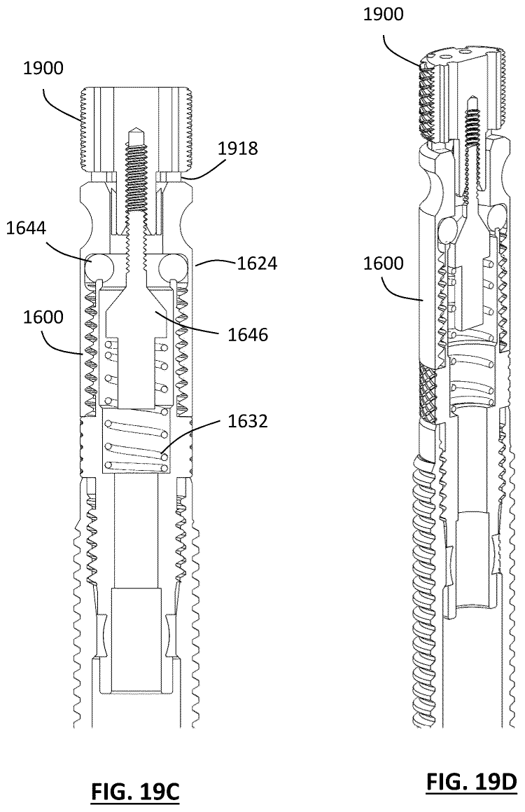

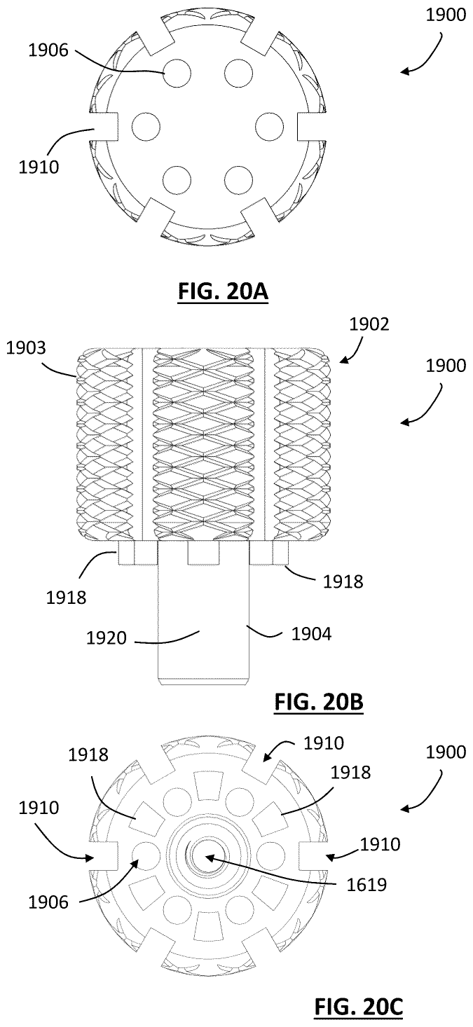

Referring now to FIG. 19A-19D and FIGS. 20A-20C, an embodiment of valve 1600 is shown with a dust cap 1900. The dust cap 1900 is similar to the dust cap 1800 with an upper portion 1902 and a lower portion 1904. The lower portion includes a hole 1916 with threaded elements configured to engage the pin portion 1652. The upper portion includes a plurality of holes 1906 extending through the upper portion 1902 and slots 1910 arranged on the outer surface 1903.

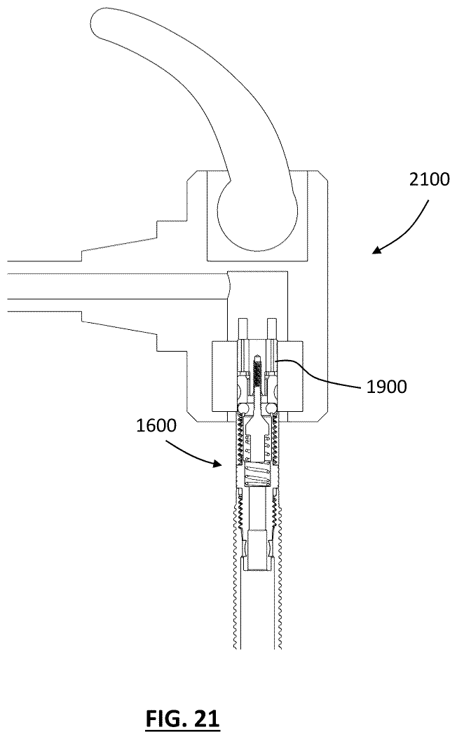

In this embodiment, the lower surface 1905 of upper portion 1902 includes a plurality of castle members 1918 that are disposed about the lower surface 1905 with gaps there between. In an embodiment, castle member 1918 are circumferentially disposed between the slots 1910 and the hold 1906. It should be appreciated that when the dust cap 1900 is installed on the pin portion 1652 and tightened against the upper surface of the cap member 1624, the castle members 1918 cause the lower surface 1905 to be offset or spaced apart from the upper surface of cap member 1624. Thus a fluid flow path is formed by the spaces or gaps between the castle members 1918 and the slots 1910 and holes 1906 with the pin passage of the cap member 1624. In effect the gaps or spaces between the castle members 1918 functionally replace the radial slots 1808 of dust cap 1800. Further, in the embodiment of FIG. 19A-19D and FIG. 20A-20C, the slots on the lower portion may be omitted and the diameter of the outer surface 1920 of the lower portion 1904 reduced to increase the space between the lower portion 1904 and the inner diameter of the pin passage in cap member 1624. This provides advantages in allowing for a higher flow of pressurized gas from the pump head 2100 (FIG. 21) into the pressure vessel.

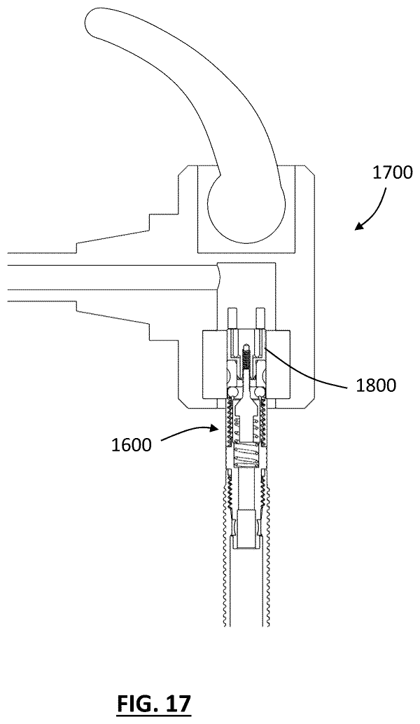

It should be appreciated that the embodiments of FIG. 16A-FIG. 21 provides advantages in providing a dust cap that: 1) pulls the sealing plug tight against the valve seat to enhance the seal when screwed down to provide additional insurance on the integrity of the seal; 2) serves as an adapter for legacy style-pump heads such as a Presta, Schrader or Dunlop pump head for example; and 3) when the dust cap is almost unscrewed or backed away from the cap member, it allows for the sealing plug to be pushed down thereby opening the valve and allow end users to easily depressurize the pressure-vessel/tire with their fingers.

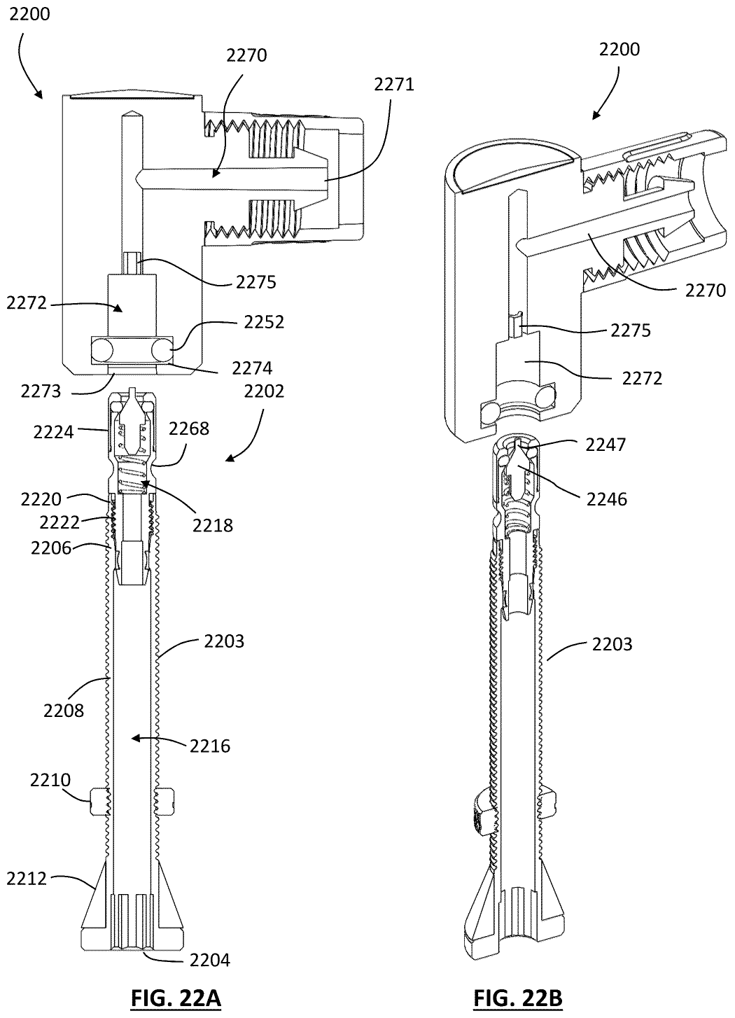

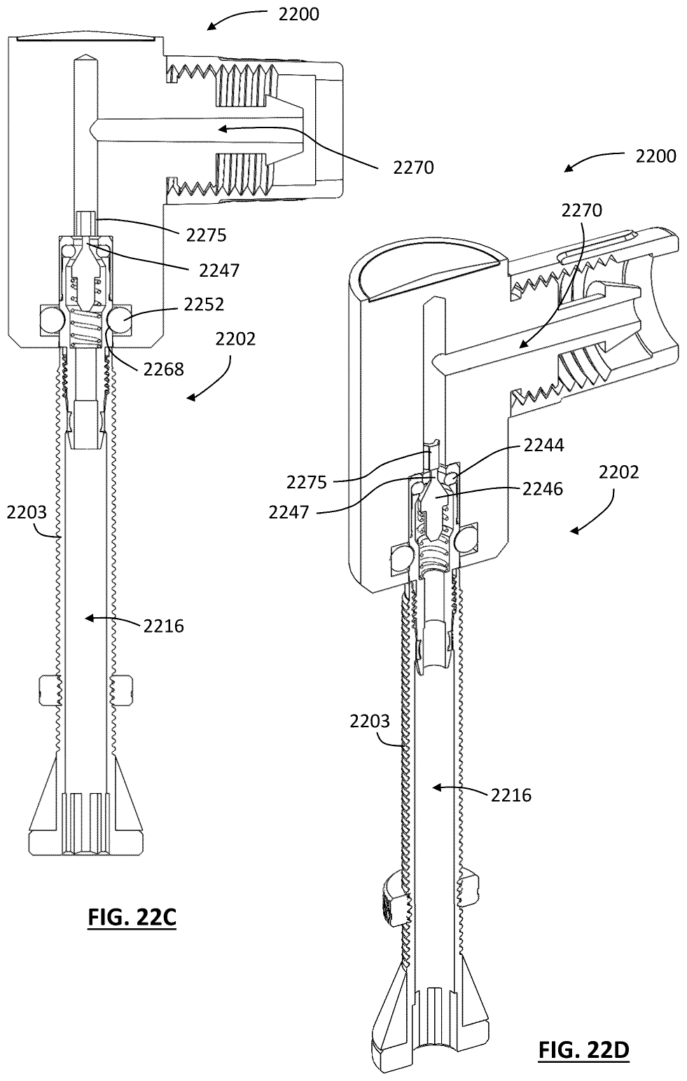

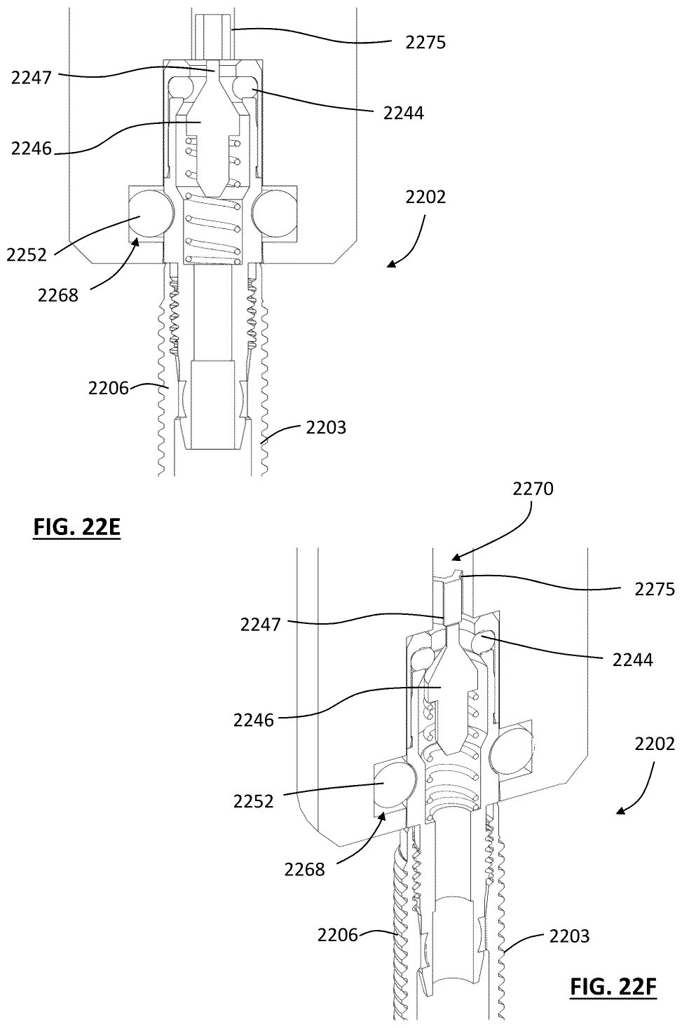

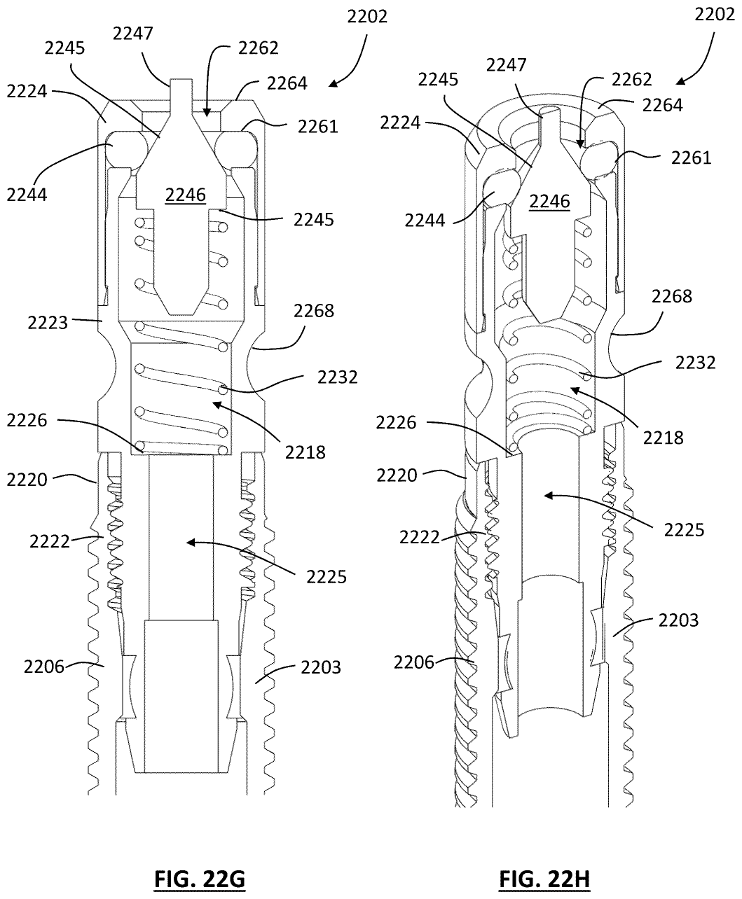

Referring now to FIG. 22A-22H, embodiments are shown of a pump head 2200 and a valve assembly 2202 where the seal between the valve and the pump head is external to the valve assembly. In this embodiment, the valve assembly 2202 includes a stem 2203 that is fluidly coupled to a pressure vessel, such as a bicycle tire or a tire inner tube for example. The stem 2203 is an elongated generally cylindrical stem body having a first end 2204 and a second end 2206. A threaded section 2208 is centrally located between the first end 2204 and the second end 2206. The threaded section is configured to receive a rim nut 2210. The rim nut 2210 cooperates with a rim gasket 2212 to sealingly couple the valve 2202 to the rim of the tubeless vessel. It should be appreciated that in embodiments where the stem 2203 is coupled to an inner tube, the gasket 2212 and rim nut 2210 may be replaced with structure suitable to the tire inner tube in a manner known in the art.

Further, it should be appreciated that while the valve 2202 illustrated in FIG. 22A-22H is a Presta type valve, this is for example purposes and the claims should not be so limited. In other embodiments, the valve 2202 may be adapted to other valve types, such as a Schrader or Dunlap type valve without deviating from the teachings herein.

The stem body 2203 has a central passage 2216 that extends from the first end 2204 to the second end 2206. In the illustrated embodiment, the central passage 2216 is coaxial with the stem body 2202. In an embodiment, the central passage includes a first counter-bore or first cavity 2218 extends inward from an end portion 2220 of the second end 2206. The end portion 2220 may include a fastener feature, such as threads 2222. The threads 2222 engage and cooperate with corresponding threads on a body 2223 to couple the body to the second end 2206. In other embodiments, the body 2223 may be coupled to the second end 2206 by other suitable fastening means, such as by crimping, welding, or adhesive bonding for example.

The body 2223 includes a central passage 2225 that is stepped from a first diameter to a second diameter to form a shoulder 2226. The shoulder 2226 supports a biasing member, such as a compression spring 2232. The compression spring 2232 bias a sealing plug 1046 towards an end 2262 of a cavity in a cap member 2224. In the illustrated embodiment, the cap member 2224 is coupled to the body 2223 by a crimp, however other fastening means may be utilized, such as but not limited to threads, welding or adhesive bonding for example.

The compression spring 2232 bias a sealing plug 2246 towards an end 2262 of a cavity in the cap member 2224. The cap member 2224 includes a circumferential slot 2268 that receives an element 2252 on the pump head 2200 to removably couple the pump head to the valve 2202. In this embodiment, the slot 2268 is positioned axially offset from the end 2264 such that the slot 2268 is closer to the shoulder 2226 than the end 2264. In other words, the seal 2244 is arranged between the slot 2268 and the end 2264.

The sealing plug 2246 includes a shoulder 2245 that engages the spring 2232. The sealing plug 2246 further includes a projection 2247 on an end opposite the spring 1032. In an embodiment, a conical surface 2248 is arranged between the projection 2247 and the shoulder 2245. In an embodiment, the conical surface 2245 engages a seal 2244 that is disposed between an end of the body 2223 and an inner surface 2261 of the cap member 2224. A passage 2262 extends from the end 2261 through an end surface 2264. When the valve 2202 is in a closed position, the seal 2244 engages the end 2261 and the conical surface 2245 and seals the passage 2262 from the central passageway 2216.

In the illustrated embodiment, the pump head 2200 includes a flow pathway 2270 that fluidly couples with a pump or pressure vessel having stored compressed gas via a port 2271. The flow pathway 2270 ends in a chamber 2272 having an outlet 2273. The chamber 2272 and outlet 2273 are sized to receive the cap member 2224 and body 2223. The chamber 2272 includes a slot 2274 sized to receive the element 2252. In the illustrated embodiment, the element 2252 is an o-ring that is sized to fit into the slot 2268 when the pump head 2220 is pushed onto the valve 2220. The o-ring 2252 has a predetermined durometer, size, sealing diameter, and cross section to cooperate with the slot 2268 to provide a desired disengagement force for removing the pump head 2200 from the valve 2202. In an embodiment, the o-ring 2252 and slot 2268 cooperate to provide a disengagement force of about 1.3 to 3.1 pounds force (5.8 to 13.8 Newtons) or a disengagement force of about 2.2 pounds force (9.8 Newtons). In another embodiment, the o-ring 2252 and slot 2268 cooperate to provide a disengagement force of about 6 to 8 pounds force (26.7 to 35.6 Newtons) or a disengagement force of about 7 pounds force (31.1 Newtons).

It should be appreciated that while the embodiment of FIG. 22A-22H illustrates the pump head 2200 as coupling to the valve assembly 2202 via an o-ring, in other embodiments other coupling mechanisms could be used including, but not limited to the slide lock attachment such as that shown and described with respect to FIG. 14A-14D or a bearing type coupling described in commonly owned U.S. Pat. No. 11,719,351 entitled Pneumatic Valve System and Method of Using the Same, the contents of which are incorporated herein by reference.

Disposed in the flow pathway 2270 at the outlet to the chamber 2272 is a projection 2275. In an embodiment, the projections 2275 is a u-shaped member with a slot extending axially along the pathway 2270. In another embodiment, the projection 2275 has an “X” shaped cross-section. It should be appreciated that the projection 2275 may have any suitable shape that allows air to flow through the pathway 2270 into the chamber 2272. The projection 2275 is positioned to engage the plug projections 2247 when the pump head 2200 is pushed onto the valve assemble 2202 (FIG. 22C, FIG. 22D). The projections 2247, 2275 cooperate to cause the plug 2246 to displace from the valve seat/seal 2244 when the pump head 2200 is coupled with the valve assembly 2202. It should be appreciated that by displacing the plug 2246, the pathway 2270 is fluidly coupled to the central passageway 2216 and the pressure vessel (e.g. tire or innertube) coupled to the valve stem 2203.

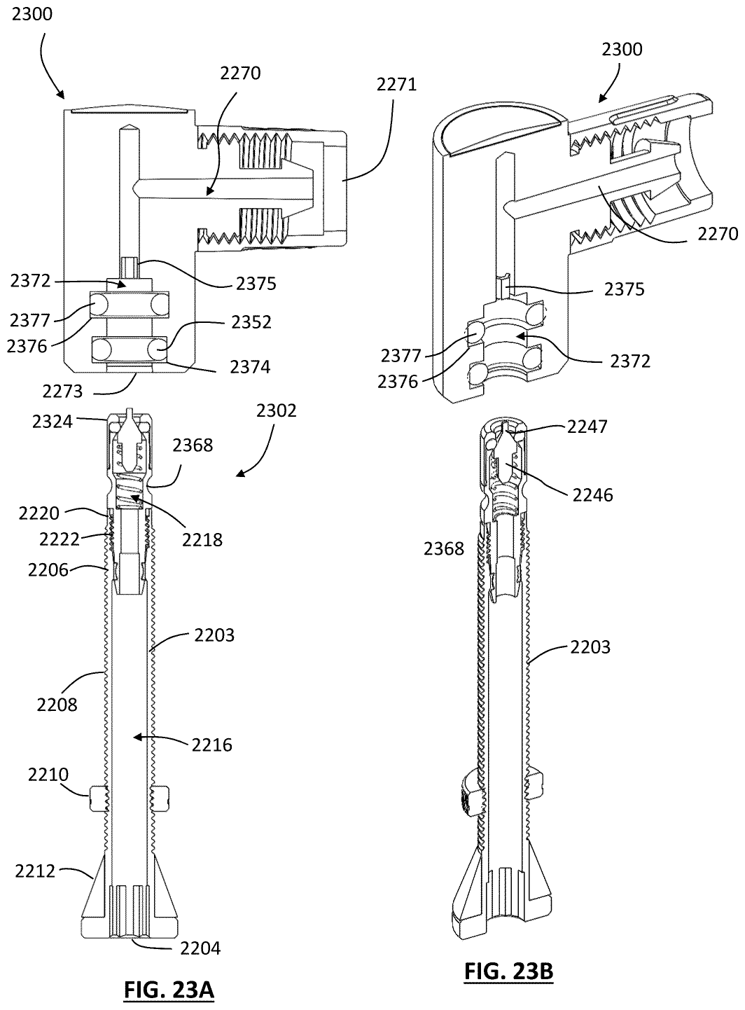

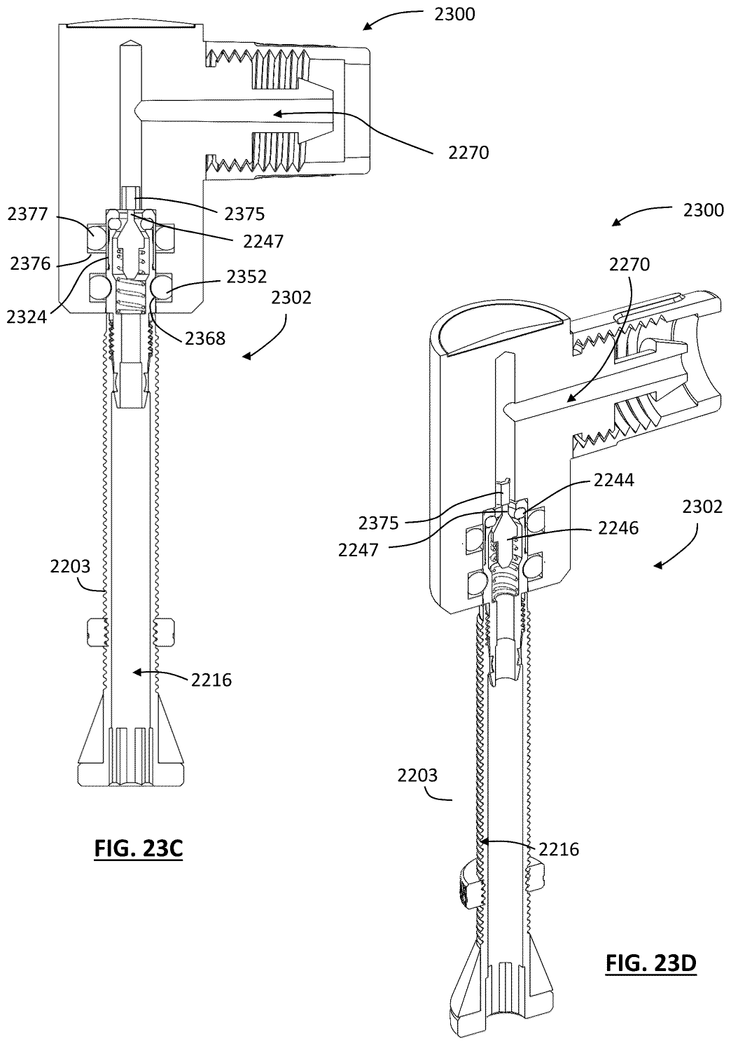

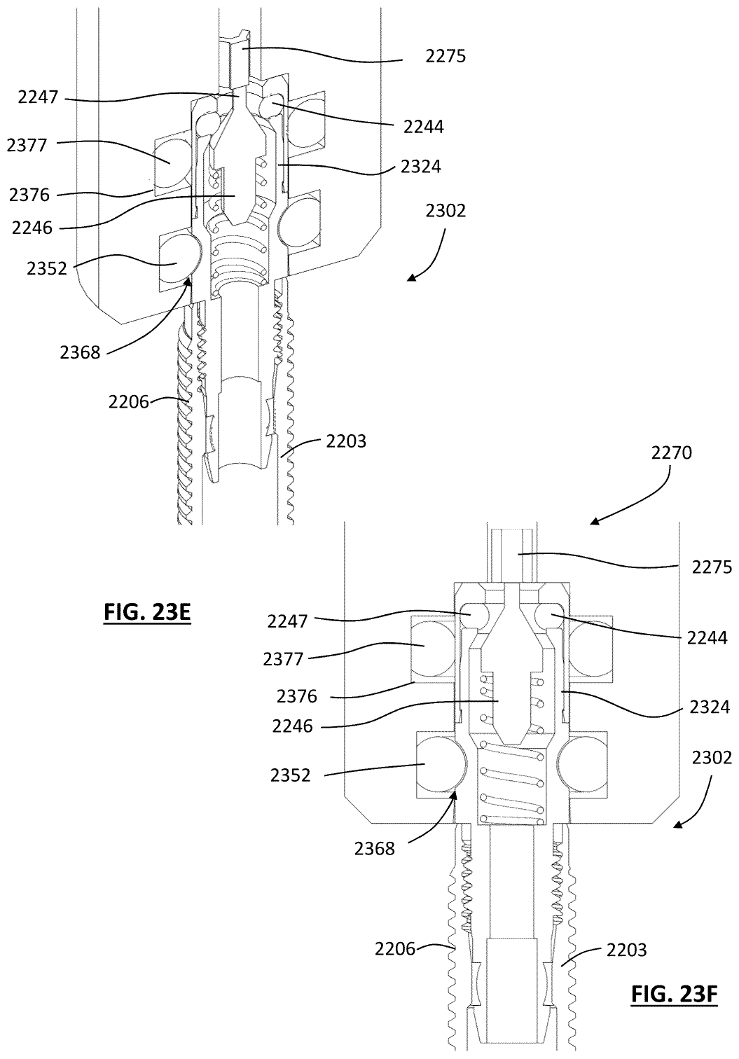

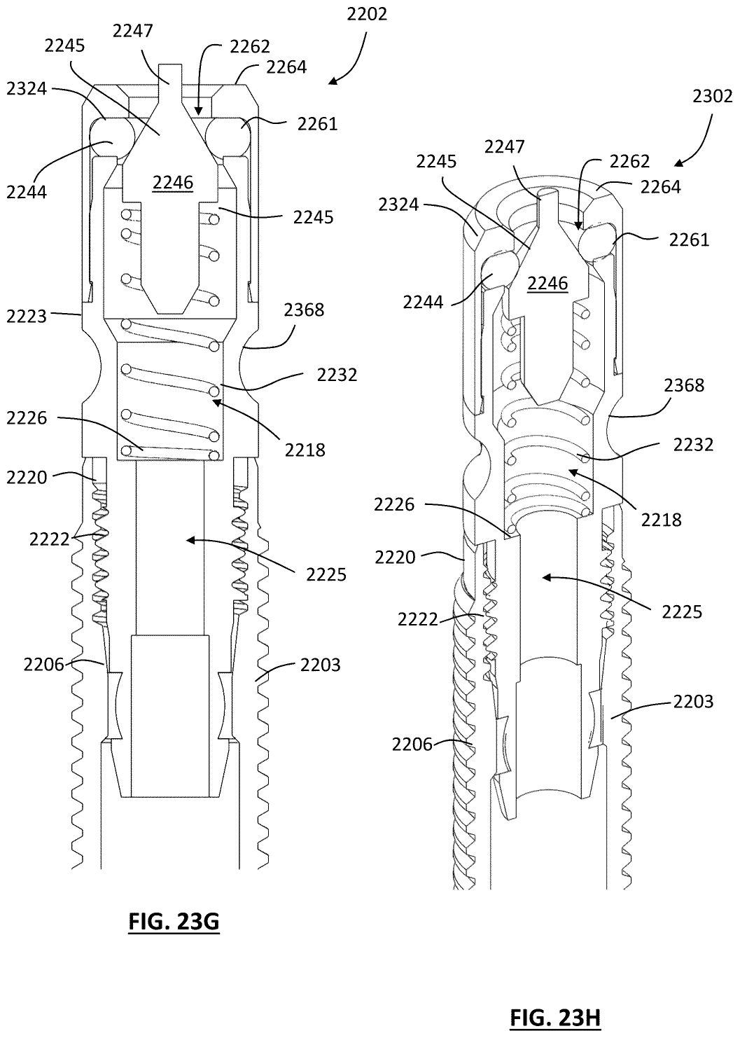

Referring now to FIG. 23A-23H, an embodiment is shown of a pump head 2300 and a valve stem assembly 2302. The valve stem assembly 2302 is constructed in the same manner as the valve stem assembly 2202 and the details of this configuration will not be repeated for brevity purposes. In this embodiment, the pump head chamber 2372 includes a first slot 2374 sized to receive a first seal or o-ring 2352. The slot 2374 and o-ring 2352 cooperate with the slot 2368 on the cap member 2324 to secure the pump head 2300 to the valve stem assembly 2302 during operation.

The chamber 2372 further includes a second slot 2376 arranged on the inner wall of chamber 2372 which is positioned between the first slot 2374 and the projection 2375. The second slot 2376 is sized to receive a sealing element or o-ring 2377. The second slot 2376 is positioned such that the o-ring 2377 will engage and seal against an outer surface of the cap member 2324 when the pump head 2300 is pushed onto the valve stem assembly 2302 and the first o-ring 2352 is positioned in the slot 2368.

It should be appreciated that the embodiment of FIG. 23A-23H provides an additional seal to reduce the risk of air leakage during operation.

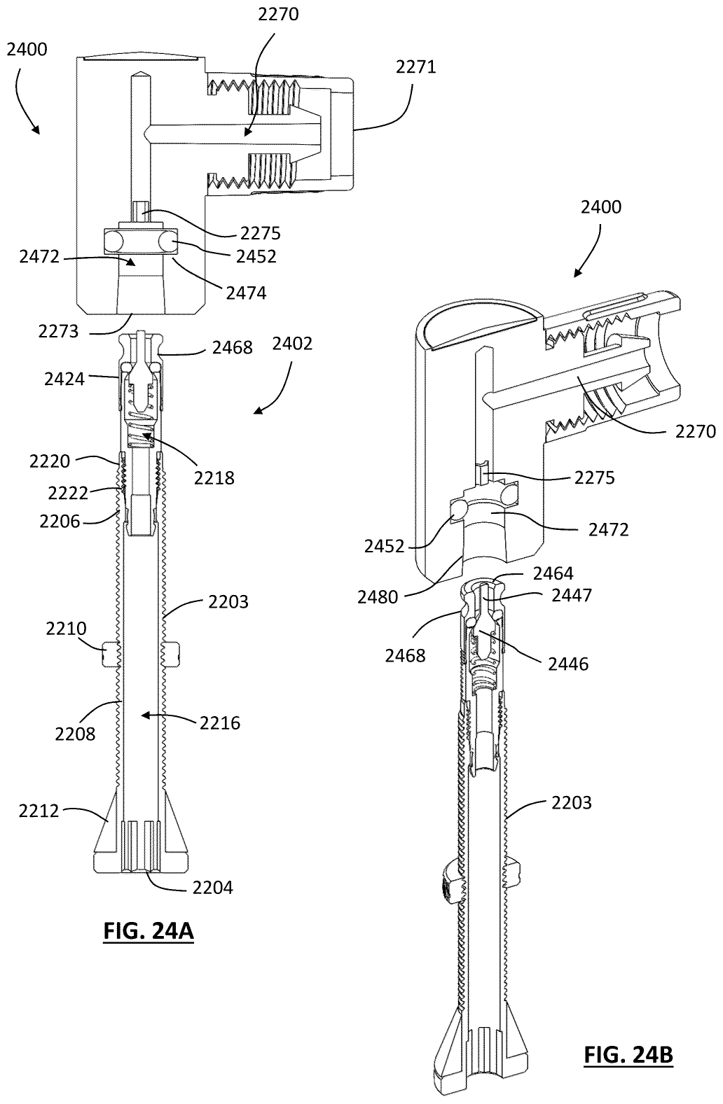

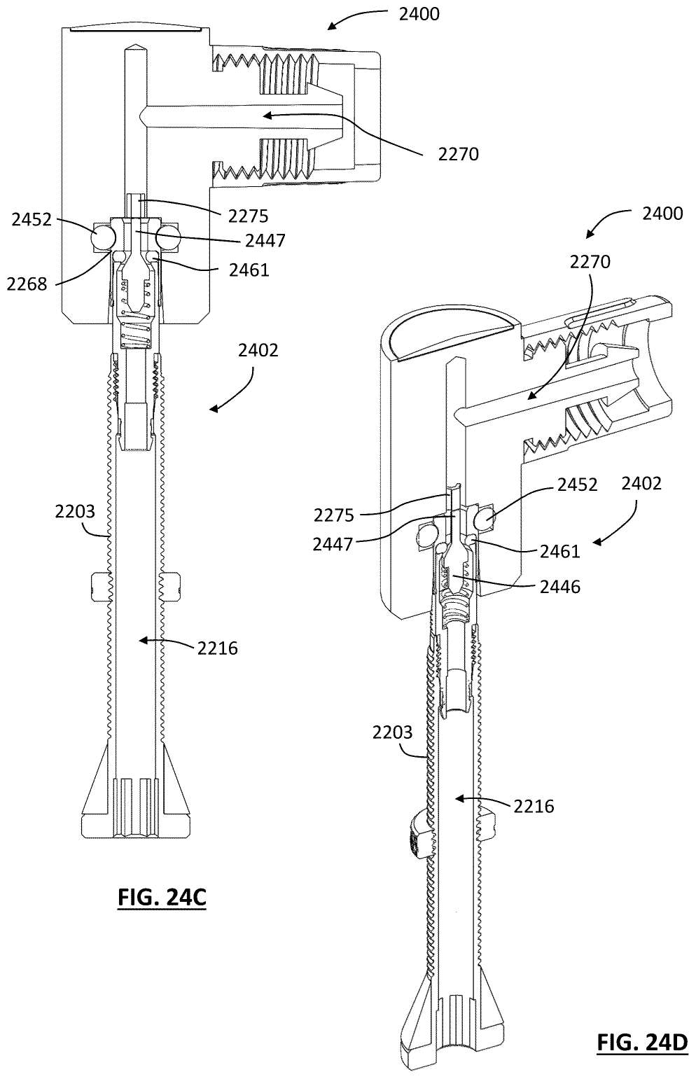

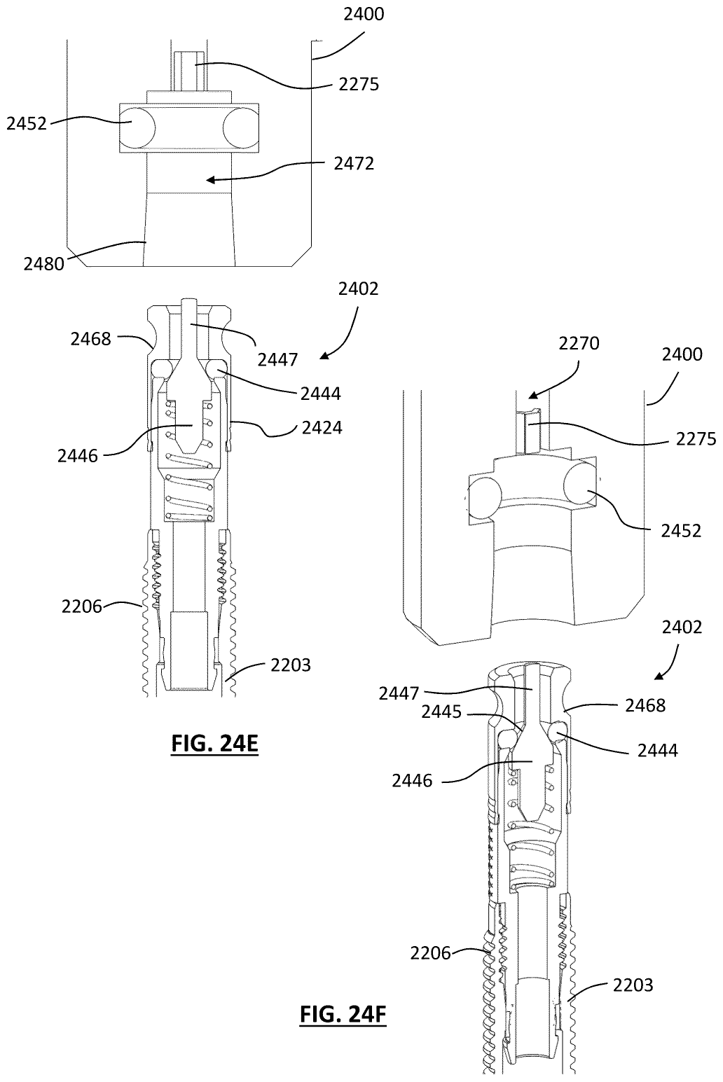

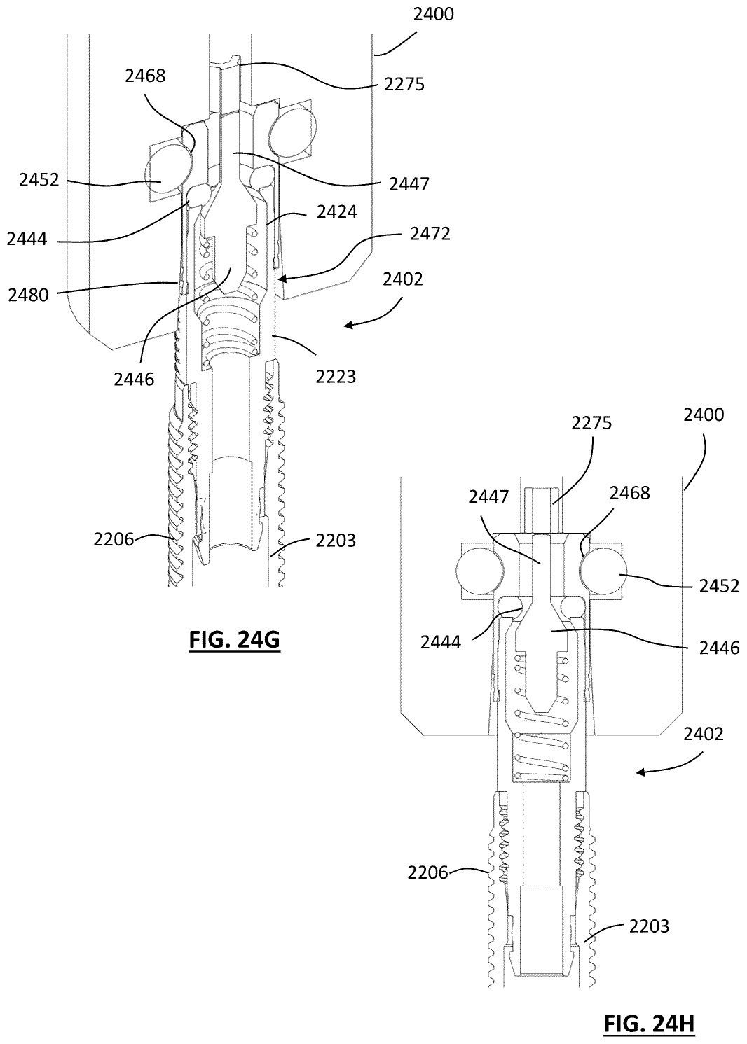

Referring now to FIG. 24A-24H, an embodiment is shown of a pump head 2400 and valve stem assembly 2402. The valve stem assembly 2402 is constructed in similar manner as the valve stem assembly 2202. However, in this embodiment, a semi-circular slot 2468 is formed on the cap member 2424 and is positioned closer to the end 2464 relative to the slot 2268 in body 2223 of FIG. 22A-22H. In other words, the semicircular slot 2468 is positioned axially between the seal 2461 and the end 2464 as opposed to the slot 2268, which is positioned on an opposite side of the seal 2261 from end 2264.

It should be appreciated that due to the positioning of the slot 2468, the chamber 2472 of the pump head 2400 is changed (relative to the embodiment of FIG. 22A-22H) to position the slot 2468 closer to the projection 2475. Further in an embodiment, the chamber 2472 includes a tapered section 2480 that facilitates insertion of the valve stem assembly 2402 into the pump head 2400. Similar to the embodiment of FIG. 22A-22H, the pump head chamber 2472 includes a slot 2474 sized to receive a first seal or o-ring 2452. The slot 2474 and o-ring 2452 cooperate with the slot 2468 on the cap member 2424 to secure the pump head 2400 to the valve stem assembly 2402 during operation.

It should be appreciated that since the slot 2468 is positioned on the cap member 2424, the projection 2447 of the plug 2446 is extended (relative to the embodiment of FIG. 22A-22H) to allow the disengagement of the conical surface 2445 from the seal 2461 when the pump head 2400 is inserted onto the valve stem assembly 2402.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

What is claimed is:

1. A pump head for a valve having a body with a circumferential slot and a seal member having a first projection, the pump head comprising:
a body having a cavity sized to receive the body, the cavity having at least one engagement member at least partially disposed within the cavity, the at least one engagement member being positioned to align with the circumferential slot when the body is disposed in the cavity; and
a second projection disposed adjacent an end of the cavity, the second projection being positioned to engage the first projection when the body is disposed in the cavity.

2. The pump head of claim 1, further comprising a flow pathway extending from the cavity to a port, the second projection being disposed at least partially within the flow pathway.

3. The pump head of claim 2, wherein the second projection is a u-shaped member.

4. The pump head of claim 3, wherein the u-shaped member includes a slot extending axially along the flow pathway.

5. The pump head of claim 2, wherein the second projection has an x-shaped cross-section.

6. The pump head of claim 1, wherein the at least one engagement member is a o-ring.

7. The pump head of claim 1, wherein the cavity includes a plurality of holes extending through a side wall of the cavity, the plurality of holes being axially positioned to align with the circumferential slot when the body is disposed in the cavity, each of the plurality of holes having a first diameter and a second diameter, the second diameter being positioned at the surface of the cavity and smaller than the first diameter.

8. The pump head of claim 7, wherein the at least one engagement member comprises a plurality of spherical elements disposed at least partially in the plurality of holes and at least partially in the cavity, the spherical elements having a largest diameter that is larger than the second diameter.

9. The pump head of claim 8, further comprising an elastomeric sleeve disposed about the circumference of the spherical elements.

10. The pump head of claim 1, further comprising a seal member coupled to the cavity, the seal member being axially disposed between the at least one engagement member and the projection.

11. The pump head of claim 10, wherein the seal member is an o-ring positioned to engage the body when the valve is disposed within the cavity.

12. A system comprising:
a pump head having:
a first body having a cavity sized to receive the body;
at least one engagement member at least partially disposed within the cavity; and
a first projection disposed adjacent an end of the cavity; and
a valve having:
a second body having a passageway and a circumferential slot, the circumferential slot being positioned to receive the at least one engagement member when the valve is disposed in the cavity;
a seal member having a second projection movably disposed within the passageway; and
a seal disposed within the passageway, the second projection being sized to engage the first projection when the valve is positioned within the cavity and displace the seal member from the seal.

13. The system of claim 12, wherein the pump head further comprises a flow pathway extending from the cavity to a port, the second projection being disposed at least partially within the flow pathway.

14. The system of claim 13, wherein the first projection is a u-shaped member.

15. The system of claim 14, wherein the u-shaped member includes a slot extending axially along the flow pathway.

16. The system of claim 13, wherein the second projection has an x-shaped cross-section.

17. The system of claim 12, wherein the at least one engagement member is a o-ring.

18. The system of claim 12, wherein the pump head further comprises a seal member at least partially disposed within the cavity, the seal member being axially disposed between the at least one engagement member and the first projection.

19. The system of claim 18, wherein seal member and an outer surface of the second body are configured to cooperate to form a seal when the valve is disposed within the cavity.

20. The system of claim 19, wherein the at least one engagement member is an o-ring.
